(19) United States
(12) Patent Application Publication
(10) Pub. No.: US 2008/0031279 A1
(43) Pub. Date: Feb. 7, 2008

(54) Network chip and network transmission/reception device

(76) Inventors: Takeshi Hatakeyama, Osaka (JP); Masataka Irie, Osaka (JP); Akifumi Nagao, Osaka (JP); Takeshi Yoshida, Osaka (JP)

Correspondence Address: MCDERMOTT WILL & EMERY LLP, 600 13TH STREET, NW, WASHINGTON, DC, 20005-3096, US

(21) Appl. No.: 11/878,512

(22) Filed: Jul. 25, 2007

(30) Foreign Application Priority Data
Aug. 3, 2006 (JP) 2006-212342

(51) Int. Cl. H04J 3/00

(52) U.S. Cl. 370/476

(57) ABSTRACT

Provided is a network chip that controls issuance of interrupts based on the contents of the received packets. The network chip receives a data packet containing a type that indicates a realtime packet or a not-realtime packet, where the realtime packet needs consideration of delay time, and the not-realtime packet does not need consideration of delay time. The network chip obtains a type by analyzing the received packet. When the obtained type indicates a realtime packet, the network chip stores the received packet into a realtime reception packet buffer, and issues an interrupt to the CPU immediately; and when the obtained type indicates a not-realtime packet, it stores the received packet into a not-realtime reception packet buffer, and issues an interrupt to the CPU after a predetermined time period passes, or after the number of packets stored in the not-realtime reception packet buffer reaches a predetermined number.

This application is based on an application No. 2006-212342 filed in Japan, the content of which is hereby incorporated by reference.

### BACKGROUND OF THE INVENTION

(1) Field of the Invention

The present invention relates to a technology for causing a network chip to control interrupts issued to the CPU (Central Processing Unit).

(2) Description of the Related Art

Conventionally known are a network chip and a network transmission/reception device that are structured to reduce the number of interrupts issued from the network chip to the CPU, allowing the CPU to sleep for a longer period, and thus saving the power consumed by the device.

Document 1 identified below has disclosed such a technology, for example.

In this technology, the network chip receives a data packet (hereinafter, merely referred to as a packet), and stores the received packet into a buffer. The network chip issues an interrupt to the CPU after a predetermined time periods passes since the receipt of the packet, or after the number of packets stored in the buffer reaches a predetermined number.

With the above-described structure, the network chip has a reduced number of interrupts, compared with the case where the network chip issues an interrupt to the CPU each time it receives a packet. This structure thus extends the sleep period of the CPU, thereby achieving a power-saving network transmission/reception device.

However, the above-described network chip cannot control the issuance of the interrupts based on the contents of the received packets.

For example, even if the data contained in a received packet should be processed immediately, the data is not processed until the above-described conventional network chip issues an interrupt to the CPU after a predetermined time periods passes since the receipt of the packet, or after the number of packets stored in the buffer reaches a predetermined number.

The object of the present invention is therefore to provide a network chip, a network transmission/reception device, and an interrupt control method that are able to control the issuance of the interrupts based on the contents of the received packets.

Document 1: Japanese Patent Application Publication No. 2005-267294

### SUMMARY OF THE INVENTION

The above object is fulfilled by a network chip that is provided together with a central processing unit in a device and transmits and receives data packets to/from an external device that is connected thereto by a network, the network chip comprising: an analyzing unit operable to analyze a data packet received from the external device; a judging unit operable to judge,, in accordance with a result of the analysis of the received data packet, whether or not an interrupt should be immediately issued to the central processing unit to request processing of the received data packet; a timer unit operable to, when the judging unit judges that the interrupt should not be immediately issued, start measuring a time, and after a predetermined time period passes thereafter, make a notification that the interrupt should be issued; and a control unit operable to issue the interrupt to the central processing unit, in accordance with either the analysis result or the notification made by the timer unit.

With the above-described structure, the network chip can analyze a received data packet and issue an interrupt either immediately or after a predetermined set period passes, based on the analysis result.

In the above-stated network chip, the data packet may include an attribute that indicates a level of importance of the data packet, the analyzing unit analyzes the attribute of the data packet received from the external device, the judging unit judges, in accordance with a result of the analysis of the attribute, whether or not the received data packet is important, and the control unit issues the interrupt immediately to the central processing unit when the judging unit judges that the received data packet is important.

With the above-described structure, the network chip judges whether or not the received data packet is important, based on the attribute of the received data packet. This enables the issuance of the interrupts to the CPU to be controlled based on the attribute of the received data packet.

In the above-stated network chip, the attribute may be type information that indicates a type of the data packet that is either a realtime packet or a not-realtime packet, where the realtime packet needs consideration of delay time, and the not-realtime packet does not need consideration of delay time, the analyzing unit obtains a type from the received data packet by analyzing the received data packet, and the judging unit judges that the received data packet is important when the type obtained by the analyzing unit indicates the realtime packet.

With the above-described structure, the network chip issues an interrupt to the CPU immediately after it detects that the received data packet is a realtime packet. Namely, the network chip with this structure, as distinguished from the conventional network chip, does not need to restrict the issuance of the interrupt until a predetermined time periods passes since the receipt of the packet, or until the number of packets stored in the buffer reaches a predetermined number. That is to say, the network chip of the present invention issues an interrupt to the CPU immediately after it detects that the received data packet is a realtime packet, thus reducing the delay time for the realtime packets compared with the conventional technology.

In the above-stated network chip, the attribute may be application information that indicates an application by which the data packet should be processed, the network chip is connected to the network but is not connected in an application level, and preliminarily stores specification information that indicates an application specified by the central processing unit, the analyzing unit analyzes whether or not the received data packet is a data packet of an application, and when the analyzing unit analyzes that the received data packet is a data packet of an application, the judging unit judges, in accordance with the application information included in the received data packet, whether or not the received data packet is a data packet of the application indicated by the specification information, and judges that the received data packet is important when the judging unit judges that the received data packet is a data packet of the application indicated by the specification information.

With the above-described structure, the network chip issues an interrupt to the CPU when the received data packet is a data packet of the application indicated by the specification information specified by the CPU. Accordingly, the CPU does not need to process data packets other than the data packets of the applications specified by the CPU. This decreases the process performed by the CPU.

In the above-stated network chip, the application information may be a first port number for identifying an application by which the data packet should be processed, the specification information is a second port number for identifying the application specified by the central processing unit, and the judging unit judges that the received data packet is a data packet of the application indicated by the specification information when the first port number matches the second port number.

With the above-described structure, the network chip can judge whether or not the received data packet is a data packet of the application indicated by the specification information specified by the CPU, by using the first port number contained in the received data packet and the second port number that is preliminarily stored.

In the above-stated network chip, the attribute may be a network identifier for identifying the network, the network chip is not connected to the network and preliminarily stores a specification identifier for identifying a network specified by the central processing unit, the analyzing unit obtains the network identifier from the received data packet by analyzing the received data packet, and the judging unit judges whether or not the network identifier obtained from the received data packet matches the preliminarily stored specification identifier, and judges that the received data packet is important when the judging unit judges that the network identifier matches the specification identifier.

With the above-described structure, the network chip issues an interrupt to the CPU when the received data packet is a data packet of the network specified by the CPU. Accordingly, the CPU does not need to process data packets other than the data packets of the networks specified by the CPU. This decreases the process performed by the CPU.

In the above-stated network chip, the data packet including the network identifier may be a beacon packet, the analyzing unit obtains the network identifier from the received beacon packet by analyzing the received beacon packet, and the judging unit judges whether or not the network identifier obtained from the received beacon packet matches the specification identifier.

With the above-described structure, the network chip can judge whether or not the received beacon packet is a beacon packet of the network specified by the CPU, by using the network identifier contained in the received beacon packet.

In the above-stated network chip, the attribute may be destination information that indicates a transmission destination of the data packet, the analyzing unit obtains the destination information by analyzing the received data packet, and the judging unit judges whether or not the transmission destination indicated by the destination information is the device that includes the network chip, and judges that the received data packet is important when the judging unit judges that the transmission destination indicated by the destination information is the device that includes the network chip.

With the above-described structure, the network chip issues an interrupt to the CPU when the received data packet is destined for a device that includes the network chip itself. Accordingly, the CPU does not need to process data packets other than the data packets destined for the device including the network chip itself. This decreases the process performed by the CPU.

In the above-stated network chip, the destination information may be a destination IP address for identifying a transmission destination device, the network chip preliminarily stores a device IP address that is assigned to the device that includes the network chip, and the judging unit judges that the data packet is destined for the device that includes the network chip when the device IP address matches the destination IP address.

With the above-described structure, the network chip can judge whether or not the received data packet is a data packet destined for the own device, by using the destination IP address contained in the received data packet and the device IP address that is assigned to the own device.

In the above-stated network chip, the received data packet may include type information that indicates a type of the data packet that is either a realtime packet or a not-realtime packet, where the realtime packet needs consideration of delay time, and the not-realtime packet does not need consideration of delay time, the central processing unit processes one or more realtime packets stored in a predetermined storage area in a transmission process in which one or more data packets are transmitted to the external device, the network chip manages times at which the one or more data packets are transmitted in the transmission process, the analyzing unit obtains the type information from the received data packet, and stores the received data packet into the predetermined storage area when the type information indicates the realtime packet, when the type information indicates the realtime packet, the judging unit judges whether or not a time period until a next data packet transmission is equal to or larger than a predetermined time period that is allowed for as a delay time, and the control unit issues the interrupt immediately to the central processing unit when the judging unit judges that the time period until the next data packet transmission is equal to or larger than the predetermined time period.

With the above-described structure, if the time period until the next data packet transmission is equal to or larger than the predetermined time period, the received realtime packet is processed when the network chip issues an interrupt. Also, if the time period until the next data packet transmission is smaller than the predetermined time period, the realtime packet is processed when the CPU performs the transmission process. Accordingly, received realtime packets are never processed after the predetermined time period, which is allowed for as a delay time, passes.

Further, the network chip of the present invention issues an interrupt if the time period until the next data packet transmission is equal to or larger than the predetermined time period. This enables the number of interrupts to be reduced, compared with the case an interrupt is issued each time a realtime packet is received.

In the above-stated network chip, the network chip may include a time storage area preliminarily storing a transmission time interval at which data packets are transmitted, and manages the times at which the one or more data packets are transmitted, in accordance with the transmission time interval.

With the above-described structure, the network chip can manage the time period until the next data packet transmission is performed, based on the transmission time interval.

In the above-stated network chip, the network chip may preliminarily store history information that indicates transmission times at which a plurality of data packets were transmitted respectively in past, and the judging unit detects a transmission time at which a next data packet is to be transmitted, in accordance with the history information, and judges whether the detected transmission time is within a predetermined time range.

With the above-described structure, the network chip can manage the time period until the next data packet transmission is performed, based on the history information.

In the above-stated network chip, data packets transmitted from the external device may be classified into a plurality of types, the external device transmits data packets of a same type to the network chip in one burst transfer period, where a plurality of burst transfer periods are provided respectively in correspondence with the plurality of types of data packets, the network chip preliminarily stores time periods of the plurality of burst transfer periods that correspond to the plurality of types of data packets, and receives data packets of a same type in one burst transfer period, the analyzing unit analyzes a data packet that is received first in a burst transfer period and obtains a time period of the burst transfer period corresponding to a type of the received data packet, the judging unit judges whether or not a current time is within the burst transfer period based on the obtained time period of the burst transfer period, and the control unit does not issue the interrupt immediately to the central processing unit when the judging unit judges that the current time is within the burst transfer period.

With the above-described structure, the network chip restricts the issuance of the interrupt during the burst transfer period, and does not need to issue an interrupt each time it receives a data packet. This reduces the number of interrupts.

In the above-stated network chip, the network chip may store one or more data packets, which were received during an interrupt process, into a predetermined packet storage area, after a burst transfer is completed, the judging unit judges whether a predetermined time period has passed since a receipt of a start data packet that is stored first in the predetermined packet storage area, and whether number of data packets stored in the predetermined packet storage area is equal to or larger than a predetermined number, and the control unit issues the interrupt immediately to the central processing unit when the judging unit judges either that the predetermined time period has passed since the receipt of the start data packet or that the number of data packets stored in the predetermined packet storage area is equal to or larger than the predetermined number.

With the above-described structure, the network chip judges to issue an interrupt when it is judged, after a burst transfer is completed, either that the predetermined time period has passed since the receipt of the start data packet of the packet storage area, or that the number of data packets stored in the packet storage area is equal to or larger than the predetermined number. This reduces the number of interrupts.

In the above-stated network chip, after a burst transfer is completed, the judging unit may judge that the interrupt should be immediately issued, and the control unit may issue the interrupt immediately to the central processing unit when the judging unit judges that the interrupt should be immediately issued.

With the above-described structure, the network chip judges to issue an interrupt after a burst transfer is completed. This reduces the number of interrupts.

The above object is also fulfilled by a network transmission/reception device comprising a central processing unit and a network chip that transmits and receives data packets to/from an external device that is connected thereto by a network, wherein the network chip includes: an analyzing unit operable to analyze a data packet received from the external device; a judging unit operable to judge, in accordance with a result of the analysis of the received data packet, whether or not an interrupt should be immediately issued to the central processing unit to request processing of the received data packet; a timer unit operable to, when the judging unit judges that the interrupt should not be immediately issued, start measuring a time, and after a predetermined time period passes thereafter, make a notification that the interrupt should be issued; and a control unit operable to issue the interrupt to the central processing unit, in accordance with either the analysis result or the notification made by the timer unit, wherein the central processing unit processes the received data packet when the central processing unit receives the interrupt issued from the network chip.

With the above-described structure, the network transmission/reception device can analyze a received data packet and issue an interrupt either immediately or after a predetermined set period passes, based on the analysis result.

In the above-stated network transmission/reception device, the data packet may include an attribute that indicates a level of importance of the data packet, the analyzing unit analyzes the attribute of the data packet received from the external device, the judging unit judges, in accordance with a result of the analysis of the attribute, whether or not the received data packet is important, and the control unit issues the interrupt immediately to the central processing unit when the judging unit judges that the received data packet is important.

With the above-described structure, the network transmission/reception device judges whether or not the received data packet is important, based on the attribute of the received data packet. This enables the issuance of the interrupts to the CPU to be controlled based on the attribute of the received data packet.

In the above-stated network transmission/reception device, the attribute may be type information that indicates a type of the data packet that is either a realtime packet or a not-realtime packet, where the realtime packet needs consideration of delay time, and the not-realtime packet does not need consideration of delay time, the analyzing unit obtains a type from the received data packet by analyzing the received data packet, and the judging unit judges that the received data packet is important when the type obtained by the analyzing unit indicates the realtime packet.

With the above-described structure, the network transmission/reception device issues an interrupt to the CPU immediately after it detects that the received data packet is a realtime packet. Namely, the network chip with this structure, as distinguished from the conventional network chip, does not need to restrict the issuance of the interrupt until a predetermined time periods passes since the receipt of the packet, or until the number of packets stored in the buffer reaches a predetermined number. That is to say, the network chip of the present invention issues an interrupt to the CPU immediately after it detects that the received data packet is a realtime packet, thus reducing the delay time for the realtime packets compared with the conventional technology.

In the above-stated network transmission/reception device, the attribute may be application information that indicates an application by which the data packet should be processed, the network chip is connected to the network but is not connected in an application level, and preliminarily stores specification information that indicates an application specified by the central processing unit, the analyzing unit analyzes whether or not the received data packet is a data packet of an application, and when the analyzing unit analyzes that the received data packet is a data packet of an application, the judging unit judges, in accordance with the application information included in the received data packet, whether or not the received data packet is a data packet of the application indicated by the specification information, and judges that the received data packet is important when the judging unit judges that the received data packet is a data packet of the application indicated by the specification information.

With the above-described structure, the network transmission/reception device issues an interrupt to the CPU when the received data packet is a data packet of the application indicated by the specification information specified by the CPU. Accordingly, the CPU does not need to process data packets other than the data packets of the applications specified by the CPU. This decreases the process performed by the CPU.

In the above-stated network transmission/reception device, the application information is a first port number for identifying an application by which the data packet should be processed, the specification information is a second port number for identifying the application specified by the central processing unit, and the judging unit judges that the received data packet is a data packet of the application indicated by the specification information when the first port number matches the second port number.

With the above-described structure, the network transmission/reception device can judge whether or not the received data packet is a data packet of the application indicated by the specification information specified by the CPU, by using the first port number contained in the received data packet and the second port number that is preliminarily stored.

In the above-stated network transmission/reception device, the attribute may be a network identifier for identifying the network, the network chip is not connected to the network and preliminarily stores a specification identifier for identifying a network specified by the central processing unit, the analyzing unit obtains the network identifier from the received data packet by analyzing the received data packet, and the judging unit judges whether or not the network identifier obtained from the received data packet matches the preliminarily stored specification identifier, and judges that the received data packet is important when the judging unit judges that the network identifier matches the specification identifier.

With the above-described structure, the network transmission/reception device issues an interrupt to the CPU when the received data packet is a data packet of the network specified by the CPU. Accordingly, the CPU does not need to process data packets other than the data packets of the networks specified by the CPU. This decreases the process performed by the CPU.

In the above-stated network transmission/reception device, the data packet including the network identifier may be a beacon packet, the analyzing unit obtains the network identifier from the received beacon packet by analyzing the received beacon packet, and the judging unit judges whether or not the network identifier obtained from the received beacon packet matches the specification identifier.

With the above-described structure, the network transmission/reception device can judge whether or not the received beacon packet is a beacon packet of the network specified by the CPU, by using the network identifier contained in the received beacon packet.

In the above-stated network transmission/reception device, the attribute may be destination information that indicates a transmission destination of the data packet, the analyzing unit obtains the destination information by analyzing the received data packet, and the judging unit judges whether or not the transmission destination indicated by the destination information is the device that includes the network chip, and judges that the received data packet is important when the judging unit judges that the transmission destination indicated by the destination information is the device that includes the network chip.

With the above-described structure, the network transmission/reception device issues an interrupt to the CPU when the received data packet is destined for a device that includes the network chip itself. Accordingly, the CPU does not need to process data packets other than the data packets destined for the device including the network chip itself. This decreases the process performed by the CPU.

In the above-stated network transmission/reception device, the destination information may be a destination IP address for identifying a transmission destination device, the network chip preliminarily stores a device IP address that is assigned to the device that includes the network chip, and the judging unit judges that the data packet is destined for the device that includes the network chip when the device IP address matches the destination IP address.

With the above-described structure, the network transmission/reception device can judge whether or not the received data packet is a data packet destined for the own device, by using the destination IP address contained in the received data packet and the device IP address that is assigned to the own device.

In the above-stated network transmission/reception device, the received data packet may include type information that indicates a type of the data packet that is either a realtime packet or a not-realtime packet, where the realtime packet needs consideration of delay time, and the not-realtime packet does not need consideration of delay time, the central processing unit processes one or more realtime packets stored in a predetermined storage area in a transmission process in which one or more data packets are transmitted to the external device, the network chip manages times at which the one or more data packets are transmitted in the transmission process, the analyzing unit obtains the type information from the received data packet, and stores the received data packet into the predetermined storage area when the type information indicates the realtime packet, when the type information indicates the realtime packet, the judging unit judges whether or not a time period until a next data packet transmission is equal to or larger than a predetermined time period that is allowed for as a delay time, and the control unit issues the interrupt immediately to the central processing unit when the judging unit judges that the time period until the next data packet transmission is equal to or larger than the predetermined time period.

With the above-described structure, if the time period until the next data packet transmission is equal to or larger than the predetermined time period, the received realtime packet is processed when the network chip issues an interrupt. Also, if the time period until the next data packet transmission is smaller than the predetermined time period, the realtime packet is processed when the CPU performs the transmission process. Accordingly, received realtime packets are never processed after the predetermined time period, which is allowed for as a delay time, passes.

Further, the network chip of the present invention issues an interrupt if the time period until the next data packet transmission is equal to or larger than the predetermined time period. This enables the number of interrupts to be reduced, compared with the case an interrupt is issued each time a realtime packet is received.

In the above-stated network transmission/reception device, the network chip may include a time storage area preliminarily storing a transmission time interval at which data packets are transmitted, and manages the times at which the one or more data packets are transmitted, in accordance with the transmission time interval.

With the above-described structure, the network transmission/reception device can manage the time period until the next data packet transmission is performed, based on the transmission time interval.

In the above-stated network transmission/reception device, the network chip may preliminarily store history information that indicates transmission times at which a plurality of data packets were transmitted respectively in past, and the judging unit detects a transmission time at which a next data packet is to be transmitted, in accordance with the history information, and judges whether the detected transmission time is within a predetermined time range.

With the above-described structure, the network transmission/reception device can manage the time period until the next data packet transmission is performed, based on the history information.

In the above-stated network transmission/reception device, data packets transmitted from the external device may be classified into a plurality of types, the external device transmits data packets of a same type to the network chip in one burst transfer period, where a plurality of burst transfer periods are provided respectively in correspondence with the plurality of types of data packets, the network chip preliminarily stores time periods of the plurality of burst transfer periods that correspond to the plurality of types of data packets, and receives data packets of a same type in one burst transfer period, the analyzing unit analyzes a data packet that is received first in a burst transfer period and obtains a time period of the burst transfer period corresponding to a type of the received data packet, the judging unit judges whether or not a current time is within the burst transfer period based on the obtained time period of the burst transfer period, and the control unit does not issue the interrupt immediately to the central processing unit when the judging unit judges that the current time is within the burst transfer period.

With the above-described structure, the network transmission/reception device restricts the issuance of the interrupt during the burst transfer period, and does not need to issue an interrupt each time it receives a data packet. This reduces the number of interrupts.

In the above-stated network transmission/reception device, the network chip may store one or more data packets, which were received during an interrupt process, into a predetermined packet storage area, after a burst transfer is completed, the judging unit judges whether a predetermined time period has passed since a receipt of a start data packet that is stored first in the predetermined packet storage area, and whether number of data packets stored in the predetermined packet storage area is equal to or larger than a predetermined number, and the control unit issues the interrupt immediately to the central processing unit when the judging unit judges either that the predetermined time period has passed since the receipt of the start data packet or that the number of data packets stored in the predetermined packet storage area is equal to or larger than the predetermined number.

With the above-described structure, the network transmission/reception device judges to issue an interrupt when it is judged, after a burst transfer is completed, either that the predetermined time period has passed since the receipt of the start data packet of the packet storage area, or that the number of data packets stored in the packet storage area is equal to or larger than the predetermined number. This reduces the number of interrupts.

In the above-stated network transmission/reception device, after a burst transfer is completed, the judging unit may judge that the interrupt should be immediately issued, and the control unit may issue the interrupt immediately to the central processing unit when the judging unit judges that the interrupt should be immediately issued.

With the above-described structure, the network transmission/reception device judges to issue an interrupt after a burst transfer is completed. This reduces the number of interrupts.

### BRIEF DESCRIPTION OF THE DRAWINGS

These and the other objects, advantages and features of the invention will become apparent from the following description thereof taken in conjunction with the accompanying drawings which illustrate a specific embodiment of the invention. In the drawings:

FIG. 1 shows the structure of a network transmission/reception device 10 in a transmission/reception system 1;

FIG. 2 shows a data structure of a packet;

FIG. 3 is a flowchart showing the operation of an interrupt issuing unit 151;

FIG. 4 shows the structure of a network transmission/reception device 10a;

FIG. 5 shows the structure of a network transmission/reception device 10b in a transmission/reception system 1b;

FIG. 6 is a flowchart showing the operation of an interrupt issuing unit 151b;

FIG. 7 is a flowchart showing the operation of the CPU 104b of obtaining a packet in the transmission process;

FIG. 8 shows one example of data structure of a management table T100;

FIG. 9 shows the structure of a network transmission/reception device 10c in a transmission/reception system 1c;

FIG. 10 shows the data structure of a beacon packet;

FIG. 11 shows the data structure of an application packet;

FIG. 12 is a flowchart showing the operation of an interrupt issuing unit 151c;

FIG. 13 shows the structure of a network transmission/reception device 10d in a transmission/reception system 1d;

FIG. 14 is a flowchart showing the operation of an interrupt issuing unit 151d;

FIG. 15 shows the structure of a network transmission/reception device 10e in a transmission/reception system 1e;

FIG. 16 shows the data structure of an ARP packet;

FIG. 17 is a flowchart showing the operation of an interrupt issuing unit 151e;

FIG. 18 shows the structure of a network transmission/reception device 10f in a transmission/reception system 1f;

FIG. 19 shows the data structure of a beacon packet that supports the burst transfer;

FIG. 20 shows an example of a burst transfer for a best effort packet; and

FIG. 21 is a flowchart showing the operation of an interrupt issuing unit 151f.

### DESCRIPTION OF THE PREFERRED EMBODIMENT

### 1. Embodiment 1

A transmission/reception system 1 as a preferred embodiment of the present invention will be described in the following, with reference to the attached drawings.

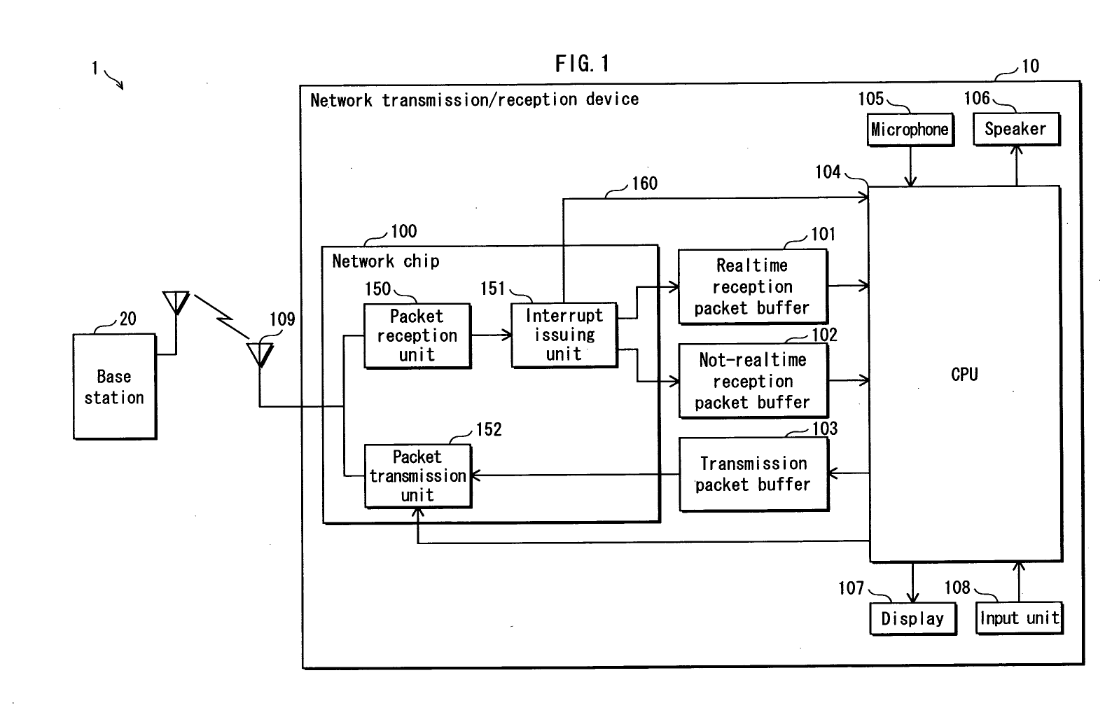

The transmission/reception system 1, as shown in FIG. 1, includes a network transmission/reception device 10 and a base station 20.

The network transmission/reception device 10 and the base station 20 perform a network communication therebetween by transmitting/receiving packets using a radio transmission path.

The packets received by the network transmission/reception device 10 from the base station 20 include (a) packets that are restricted in delay time (hereinafter referred to as realtime packets) and (b) packets that are not restricted in delay time (hereinafter referred to as not-realtime packets). Namely, the base station 20 sends, to the network transmission/reception device 10, packets that are restricted in delay time and packets that are not restricted in delay time.

Here will be described the packets received by the network transmission/reception device 10 from the base station 20.

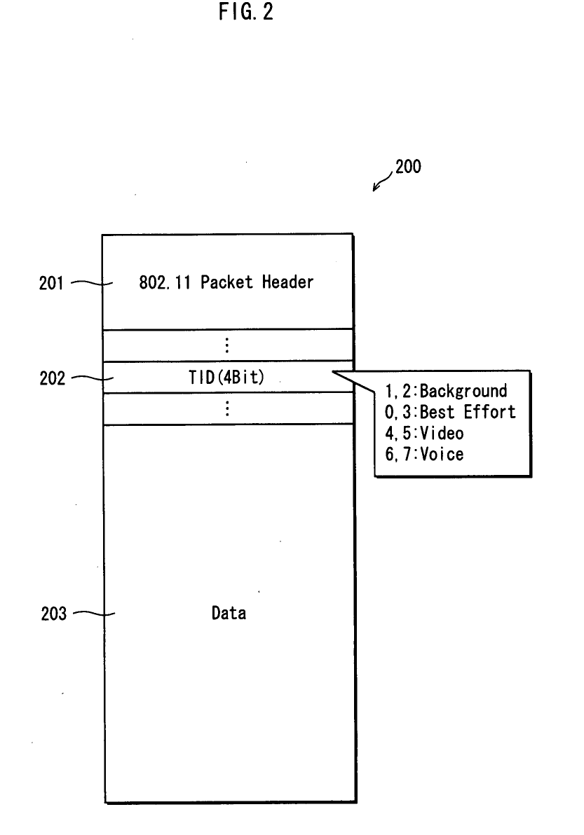

FIG. 2 shows a packet format 200 that indicates the data structure of a packet received by the network transmission/reception device 10 from the base station 20.

The packet format 200 is a format of the 802.11 packet that supports QoS (Quality of Service) that is defined in the radio LAN standard “IEEE 802.11e Media Access Control (MAC) Quality of Service Enhancement”.

The packet format 200 includes an 802.11 packet header 201, a TID (Traffic Identifiers) 202, and data 203. It should be noted here that the 802.11 packet header 201, the TID 202, and the data 203 are defined in “IEEE 802.11e Media Access Control (MAC) Quality of Service Enhancement”, and detailed description thereof is omitted here. Here, the TID 202 will be described briefly.

The TID 202 is composed of 4-bit data that defines the class of QoS. When TID=1, 2, it indicates a background packet; when TID=0, 3, it indicates a best effort packet; when TID=4, 5, it indicates a video packet; and when TID=6, 7, it indicates voice packet. That is to say, when TID=0, 1, 2, 3, it indicates a not-realtime packet that contains data for which delay time needs not to be considered, and when TID=4, 5, 6, 7, it indicates a realtime packet that contains video data, audio data or the like for which delay time needs to be considered.

Each of the packet types is known, and description thereof is omitted here.

The following will describe the structure and operation of the network transmission/reception device 10.

1.1 Structure of Network Transmission/Reception Device 10

The network transmission/reception device 10, as shown in FIG. 1, includes a network chip 100, a realtime reception packet buffer 101, a not-realtime reception packet buffer 102, a transmission packet buffer 103, a CPU 104, a microphone 105, a speaker 106, a display 107, an input unit 108, and an antenna 109.

It is presumed here that the data input/output between the CPU 104 and each of the microphone 105, the speaker 106, the display 107, and the input unit 108 is performed via a bus (not illustrated).

(1) Realtime Reception Packet Buffer 101

The realtime reception packet buffer 101 has an area for storing a received realtime packet.

It is presumed here that the size of the area of the realtime reception packet buffer 101 is larger than the size of the received packet.

(2) Not-Realtime Reception Packet Buffer 102

The not-realtime reception packet buffer 102 has an area for storing one or more received not-realtime packets.

It is presumed here that the size of the area of the not-realtime reception packet buffer 102 is large enough to store a plurality of received packet. For example, the size of the area is large enough to store five or more received packet.

(3) Transmission Packet Buffer 103

The transmission packet buffer 103 has an area for storing one or more packets to be transmitted to the base station 20.

(4) Network Chip 100

The network chip 100, as shown in FIG. 1, includes a packet reception unit 150, an interrupt issuing unit 151, and a packet transmission unit 152.

The network chip 100 receives a packet from the base station 20 via the antenna 109, and analyzes the type of the received packet. The network chip 100 determines whether or not to issue an interrupt to the CPU 104 in accordance with the analysis result of the received packet, and performs a control according to the determination.

Further, the network chip 100 transmits a packet to the base station 20 via the antenna 109.

(4-1) Packet Reception Unit 150

The packet reception unit 150, upon receiving a packet from the base station 20 via the antenna 109, outputs the received packet to the interrupt issuing unit 151.

(4-2) Interrupt Issuing Unit 151

The interrupt issuing unit 151 preliminarily stores information indicating a predetermined time period (for example, 50 ms) and a predetermined number (for example, 5).

The interrupt issuing unit 151, upon receiving a packet from the packet reception unit 150, analyzes the type of the received packet and determines whether the received packet is a realtime packet or a not-realtime packet.

### <When Received Packet is Realtime Packet>

When it determines that the received packet is a realtime packet,, the interrupt issuing unit 151 stores the received packet into the realtime reception packet buffer 101, and issues an interrupt by transmitting an interrupt signal to the CPU 104 via a signal line 160.

### <When Received Packet is Not-Realtime Packet>

When it determines that the received packet is a not-realtime packet, the interrupt issuing unit 151 stores the received packet into the not-realtime reception packet buffer 102. The interrupt issuing unit 151 issues an interrupt by transmitting an interrupt signal to the CPU 104 via the signal line 160 after the predetermined time period (for example, 50 ms) passes since the start packet in the not-realtime reception packet buffer 102 was received, or after the number of packets stored in the not-realtime reception packet buffer 102 reaches the predetermined number (for example, 5), where the predetermined time period and the predetermined number are preliminarily stored in the interrupt issuing unit 151.

Here, the operation of the interrupt issuing unit 151 will be described more specifically.

The interrupt issuing unit 151 includes an interrupt control unit for controlling the issuance of interrupts and a timer unit for measuring a time.

When the received packet is a realtime packet, namely, when an interrupt should be issued immediately, the interrupt control -unit stores the received packet into the realtime reception packet buffer 101, and issues an interrupt by transmitting an interrupt signal to the CPU 104 via the signal line 160.

When the received packet is a not-realtime packet, namely, when an interrupt should not be issued immediately, the interrupt control unit stores the received packet into the not-realtime reception packet buffer 102, and activates the timer unit. The timer unit measures the time period until the predetermined time period (for example, 50 ms) passes. Here, the interrupt control unit does not activate the timer unit when the timer unit has already been activated, and only stores the received packet into the not-realtime reception packet buffer 102.

When the measured time reaches the predetermined time period (for example, 50 ms), the timer unit outputs an interrupt issuance notification, which indicates that an interrupt should be issued, to the interrupt control unit, and stops measuring the time. Upon receiving the interrupt issuance notification, the interrupt control unit issues an interrupt by transmitting an interrupt signal to the CPU 104 via the signal line 160.

### <Example of Analysis Method>

Here will be described an example of the method for analyzing the type of the received packet.

The interrupt issuing unit 151 obtains a TID that is contained in the received packet, and judges which value among 0 through 7 is indicated by the obtained TID to analyze the type of the received packet. The interrupt issuing unit 151 determines that the received packet is a not-realtime packet when the TID contained in the received packet indicates any of 0 through 3, and determines that the received packet is a realtime packet when the TID indicates any of 4 through 7.

(4-3) Packet Transmission Unit 152

The packet transmission unit 152 receives a transmission request from the CPU 104 by receiving a transmission request signal from the CPU 104.

Upon receiving a transmission request from the CPU 104, the packet transmission unit 152 obtains a packet from the transmission packet buffer 103, and transmits the obtained packet via the antenna 109.

The packet transmission unit 152 performs this transmission operation for each packet stored in the transmission packet buffer 103.

(5) CPU 104

The CPU 104 controls the entire network transmission/reception device 10.

Upon receiving an interrupt signal from the interrupt issuing unit 151, the CPU 104 obtains the realtime packet stored in the realtime reception packet buffer 101. The CPU 104 then performs a process onto the data contained in the obtained realtime packet in accordance with the type of the obtained realtime packet. The CPU 104 then obtains the one or more not-realtime packets stored in the not-realtime reception packet buffer 102 in the order. The CPU 104 then performs a process onto the data contained in the obtained not-realtime packets in accordance with the type of the obtained not-realtime packets.

The CPU 104 deletes the packets after it performs the processes thereonto. Namely, a buffer stores no packet after the CPU 104 performs processes onto all packets stored in the buffer.

As described above, the CPU 104 performs a process onto the realtime packet stored in the realtime reception packet buffer 101, and then performs a process onto the not-realtime packets stored in the not-realtime reception packet buffer 102. Here, in case the realtime reception packet buffer 101 does not store any packet, the CPU 104 performs a process only onto the not-realtime packets stored in the not-realtime reception packet buffer 102; and in case the not-realtime reception packet buffer 102 does not store any packet, the CPU 104 performs a process only onto the realtime packet stored in the realtime reception packet buffer 101.

The processes performed onto the received packets are the same as conventional ones, and detailed description thereof is omitted here. In the following, a brief specific example thereof will be provided. That is to say, for example, when the type of a received realtime packet is “audio”, the CPU 104 performs an audio process onto the data contained in the received packet, and outputs the data, having been subjected to the audio process, to the speaker 106. When the type of a received realtime packet is “video”, the CPU 104 performs a video process onto the data contained in the received packet, and outputs the data, having been subjected to the video process, to the display 107. Also, when the received packet is a not-realtime packet, the CPU 104 performs a similar process onto the data contained in the received packet in accordance with the type of the received not-realtime packet.

Upon receiving audio data from the microphone 105, the CPU 104 generates one or more transmission packets by converting the received audio data into packets, and stores the generated one or more transmission packets into the transmission packet buffer 103.

Also, upon receiving transmission data (for example, character data) to be transmitted to the base station 20, from the input unit 108, the CPU 104 generates one or more transmission packets by converting the received transmission data into packets, and stores the generated one or more transmission packets into the transmission packet buffer 103.

The CPU 104 transmits a transmission request signal to the packet transmission unit 152 when a transmission of transmission packets is started.

The technology for converting data into packets is known, and description thereof is omitted here.

Upon receiving an instruction regarding the operation of the network transmission/reception device 10, from the input unit 108, the CPU 104 controls the operation of the network transmission/reception device 10 in accordance with the received instruction.

(6) Microphone 105

The microphone 105 receives a sound/voice from a user of the network transmission/reception device 10, generates audio data from the received sound/voice, and outputs the generated audio data to the CPU 104.

(7) Speaker 106

The speaker 106, upon receiving the audio data from the CPU 104, outputs a sound/voice based on the received audio data.

(8) Display 107

The display 107, upon receiving the video data from the CPU 104, outputs video based on the received video data.

(9) Input Unit 108

The input unit 108, upon receiving transmission data (for example, character data) from a user of the network transmission/reception device 10, outputs the received transmission data to the CPU 104.

Also, upon receiving an instruction regarding the operation of the network transmission/reception device 10, from a user of the network transmission/reception device 10, the input unit 108 outputs the received instruction to the CPU 104.

1.2 Operation of Network Transmission/Reception Device 10

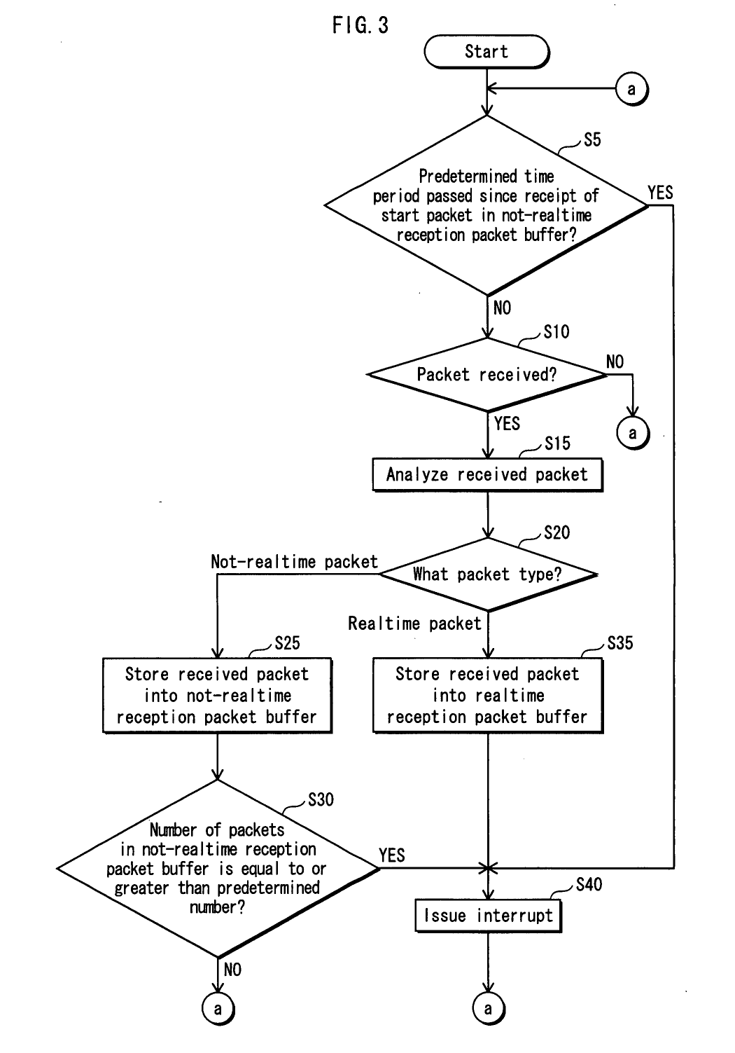

Here will be described the operation of the interrupt issuing unit 151 with reference to the flowchart shown in FIG. 3.

The interrupt issuing unit 151 judges whether or not a predetermined time period has passed since receipt of the start packet in the not-realtime reception packet buffer (step S5).

When it judges that the predetermined time period has not yet passed (NO in step S5), the interrupt issuing unit 151 judges whether or not a packet has been received from the base station 20 via the packet reception unit 150 (step S10).

When it judges that a packet has not been received (NO in step S10), the interrupt issuing unit 151 returns to step S5.

When it judges that a packet has been received,(YES in step S10), the interrupt issuing unit 151 analyzes the received packet (step S15), and determines the type of the received packet in accordance with the analysis result (step S20).

When it determines that the type of the received packet is not-realtime packet (“not-realtime packet” in step S20), the interrupt issuing unit 151 stores the received packet into the not-realtime reception packet buffer 102 (step S25). The interrupt issuing unit 151 then judges whether or not the number of packets in the not-realtime reception packet buffer 102 is equal to or greater than the predetermined number (step S30).

When it judges that the number of packets is smaller than the predetermined number (NO in step S30), the interrupt issuing unit 151 returns to step S5. When it judges that the number of packets is equal to or greater than the predetermined number (YES in step S30), the interrupt issuing unit 151 issues an interrupt by transmitting an interrupt signal to the CPU 104 (step S40). After issuing the interrupt, the interrupt issuing unit 151 returns to step S5.

When it determines that the type of the received packet is realtime packet (“realtime packet” in step S20), the interrupt issuing unit 151 stores the received packet into the realtime reception packet buffer 101 (step S35), and issues an interrupt by transmitting an interrupt signal to the CPU 104 (step S40). After issuing the interrupt, the interrupt issuing unit 151 returns to step S5.

When it judges that the predetermined time period has passed (YES in step S5), the interrupt issuing unit 151 issues an interrupt by transmitting an interrupt signal to the CPU 104 (step S40). After issuing the interrupt, the interrupt issuing unit 151 returns to step S5.

1.3 Modification to Interrupt Issuance

In the above-described Embodiment 1, an interrupt process is performed onto the realtime packet stored in the realtime reception packet buffer 101 and an interrupt process is performed onto the one or more not-realtime packets stored in the not-realtime reception packet buffer 102 in the order at a timing when the interrupt issuing unit 151 issues an interrupt. However, the present invention is not limited to this.

These interrupt processes may be performed separately at different timings.

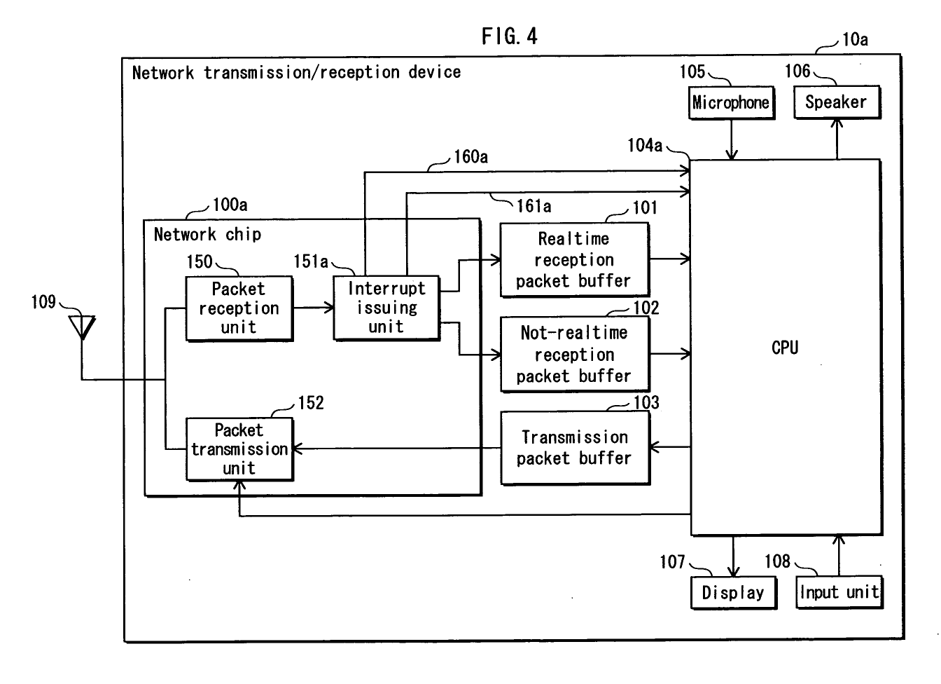

FIG. 4 shows the structure of a network transmission/reception device 10a in the present modification to Embodiment 1. Here will be described the operation of an interrupt issuing unit 151a and a CPU 104a.

The other constitutional elements operate in the same manner as those of the network transmission/reception device 10, and are assigned with the same reference signs.

(1) Interrupt Issuing Unit 151a

The interrupt issuing unit 151a preliminarily stores information indicating a predetermined time period (for example, 50 ms) and a predetermined number (for example, 5).

The interrupt issuing unit 151a, upon receiving a packet from the packet reception unit 150, analyzes the type of the received packet and determines whether the received packet is a realtime packet or a not-realtime packet.

When it determines that the received packet is a realtime packet, the interrupt issuing unit 151a stores the received packet into the realtime reception packet buffer 101, and issues an interrupt by transmitting an interrupt signal to the CPU 104a via a signal line 160a.

When it determines that the received packet is a not-realtime packet, the interrupt issuing unit 151a stores the received packet into the not-realtime reception packet buffer 102. The interrupt issuing unit 151a issues an interrupt by transmitting an interrupt signal to the CPU 104a via a signal line 161a after the predetermined time period (for example, 50 ms) passes since the start packet in the not-realtime reception packet buffer 102 was received, or after the number of packets stored in the not-realtime reception packet buffer 102 reaches the predetermined number (for example, 5), where the predetermined time period and the predetermined number are preliminarily stored in the interrupt issuing unit 151.

It should be noted here that the further specific operation of the interrupt issuing unit 151a can be achieved by having and using an interrupt control unit and a timer unit that are the same as those included in the interrupt issuing unit 151, and description thereof is omitted here.

One example of the method for analyzing the type of the received packet is to use the above-described TID to judge the type of the received packet.

(2) CPU 104a

The CPU 104a controls the entire network transmission/reception device 10a.

Upon receiving an interrupt signal from the interrupt issuing unit 151a via the signal line 160a, the CPU 104a obtains the realtime packet stored in the realtime reception packet buffer 101. The CPU 104a then performs a process onto the data contained in the obtained realtime packet in accordance with the type of the obtained realtime packet. The CPU 104a deletes the packet after it performs the process thereonto.

Upon receiving an interrupt signal from the interrupt issuing unit 151a via the signal line 161a, the CPU 104a obtains the one or more not-realtime packets stored in the not-realtime reception packet buffer 102 in the order. The CPU 104a then performs a process onto the data contained in the obtained not-realtime packets in accordance with the type of the obtained not-realtime packets. The CPU 104a deletes the packets after it performs the process thereonto.

The process performed onto each received packet is the same as in conventional technologies, and description thereof is omitted here.

The CPU 104a operates in the same manner as the CPU 104 when it receives audio data from the microphone 105, transmission data (for example, character data), which is to be transmitted to the base station 20, from the input unit 108, or an instruction regarding the operation of the network transmission/reception device 10 from the input unit 108, and description thereof is omitted here.

### (3) SUMMARY

As described above, with the above-described structure, the interrupt process onto the realtime packet stored in the realtime reception packet buffer 101 and the interrupt process onto the one or more not-realtime packets stored in the not-realtime reception packet buffer 102 are performed separately at different timings.

In the present example, two signal lines are used to cause the interrupt processes to be performed at different timings. However, not limited to this, one signal line may be used to output different interrupt signals to the CPU so that the interrupt processes are performed at different timings.

The operation in this case is as follows.

The interrupt issuing unit outputs a first interrupt signal to the CPU when it receives a realtime packet, and outputs a second interrupt signal to the CPU after a predetermined time period passes since the start packet in the not-realtime reception packet buffer was received, or after the number of packets stored in the not-realtime reception packet buffer reaches a predetermined number.

Upon receiving the first interrupt signal from the interrupt issuing unit, the CPU obtains the realtime packet stored in the realtime reception packet buffer. The CPU then performs a process onto the data contained in the obtained realtime packet in accordance with the type of the obtained realtime packet. The CPU deletes the packet after it performs the process thereonto.

Upon receiving the second interrupt signal from the interrupt issuing unit, the CPU obtains the one or more not-realtime packets stored in the not-realtime reception packet buffer in the order. The CPU then performs a process onto the data contained in the obtained not-realtime packets in accordance with the type of the obtained not-realtime packets. The CPU deletes the packets after it performs the process thereonto.

1.4 Other Modifications

Up to now, the present invention has been described through an embodiment thereof, Embodiment 1. However, the present invention is not limited to the embodiment, but includes, for example, the following modifications.

(1) In Embodiment 1 described above, a radio transmission path is used to transmit/receive a packet. However, a wired transmission path may be used instead.

(2) The present invention may be any combination of the above-described embodiment and modifications.

1.5 Summary

With the above-described operation, it is possible to achieve a low power consumption network transmission/reception device that immediately issues an interrupt when it receives a realtime packet that is restricted in delay time, and when it receives a not-realtime packet that is not restricted in delay time, issues an interrupt to the CPU after a predetermined time period passes or after a predetermined number of packets are stored in a buffer. With this structure of a network transmission/reception device that receives realtime packets and not-realtime packets, it is possible to achieve a low power consumption network transmission/reception device by reducing the number of interrupts and thus extending the CPU sleep time, as is the case with conventional technologies.

### 2. Embodiment 2

A transmission/reception system 1b as another preferred embodiment of the present invention will be described in the following, with reference to the attached drawings.

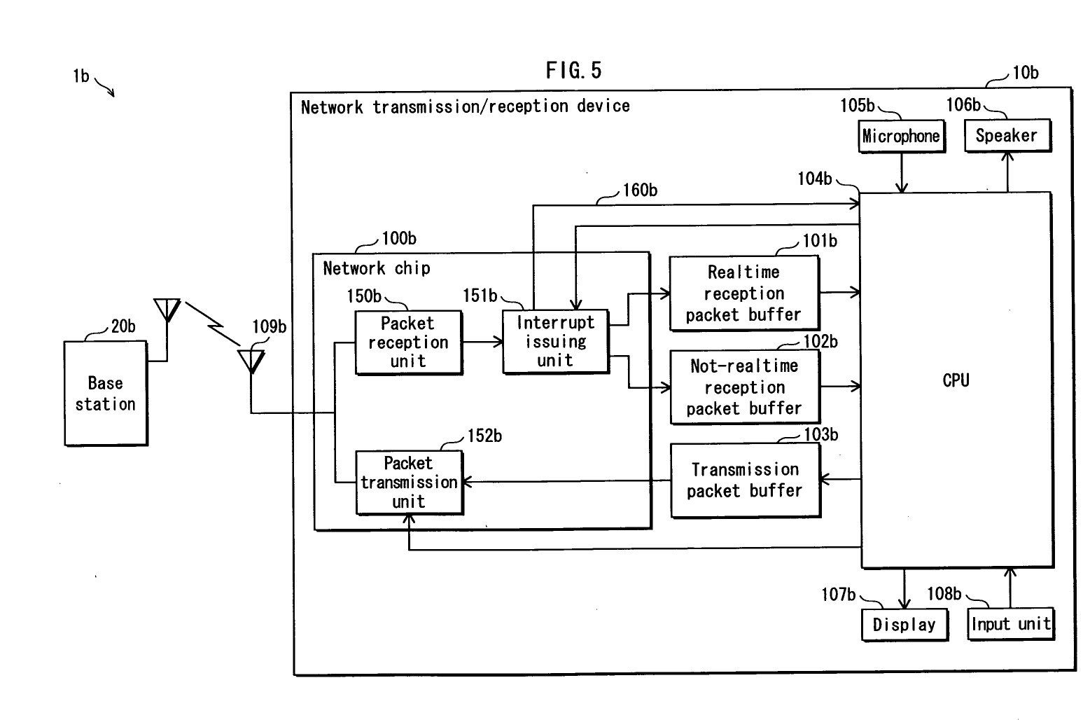

The transmission/reception system 1b, as shown in FIG. 5, includes a network transmission/reception device 10b and a base station 20b.

The network transmission/reception device 10b and the base station 20b perform a network communication therebetween by transmitting/receiving packets using a radio transmission path.

The network transmission/reception device 10b, as is the case with Embodiment 1, receives realtime packets and not-realtime packets from the base station 20b. Namely, the base station 20b sends, to the network transmission/reception device 10b, packets that are restricted in delay time and packets that are not restricted in delay time.

The packet transmission performed by the network transmission/reception device 10b differs from the packet transmission performed by the network transmission/reception device 10 in that it transmits packets at a predetermined interval (for example, at an interval of 20 ms). The packet transmission performed by the network transmission/reception device 10b conforms to, for example, VOIP (Voice Over IP) in which audio packets are transmitted and received periodically via the Internet.

Here, the data structure of the packets received by the network transmission/reception device 10b from the base station 20b is the same as that in Embodiment 1, and description thereof is omitted here. In the following description, a reference will be made to a packet format 200 shown in FIG. 2, as necessary.

The following will describe the structure and operation of the network transmission/reception device 10b.

2.1 Structure of Network Transmission/Reception Device 10b

The network transmission/reception device 10b, as shown in FIG. 5, includes a network chip 100b, a realtime reception packet buffer 101b, a not-realtime reception packet buffer 102b, a transmission packet buffer 103b, a CPU 104b, a microphone 105b, a speaker 106b, a display 107b, an input unit 108b, and an antenna 109b.

It is presumed here that the data input/output between the CPU 104b and each of the microphone 105b, the speaker 106b, the display 107b, and the input unit 108b is performed via a bus (not illustrated).

(1) Realtime Reception Packet Buffer 101b

The realtime reception packet buffer 101b has an area for storing one or more received realtime packets.

(2) Not-Realtime Reception Packet Buffer 102b

The not-realtime reception packet buffer 102b has the same structure as the not-realtime reception packet buffer 102 shown in Embodiment 1, and description thereof is omitted here.

(3) Transmission Packet Buffer 103b

The transmission packet buffer 103b has the same structure as the transmission packet buffer 103 shown in Embodiment 1, and description thereof is omitted here.

(4) Network Chip 100b

The network chip 100b, as shown in FIG. 5, includes a packet reception unit 150b, an interrupt issuing unit 151b, and a packet transmission unit 152b.

The network chip 100b receives a packet from the base station 20b via the antenna 109b, and analyzes the type of the received packet. The network chip 100b determines whether or not to issue an interrupt to the CPU 104b in accordance with the analysis result of the received packet, and performs a control according to the determination.

Further, the network chip 100b transmits packets periodically (for example, at an interval of 20 ms) to the base station 20b via the antenna 109b.

(4-1) Packet Reception Unit 150b

The packet reception unit 150b, upon receiving a packet from the base station 20b via the antenna 109b, outputs the received packet to the interrupt issuing unit 151b.

(4-2) Interrupt Issuing Unit 151b

The interrupt issuing unit 151b preliminarily stores information indicating a predetermined time period (for example, 50 ms), a predetermined number (for example, 5), and a predetermined allowed time period (for example, 10 ms).

The interrupt issuing unit 151b has a storage area for storing information indicating a packet transmission time interval (for example, 20 ms).

The interrupt issuing unit 151b receives a packet transmission time interval from the CPU 104b, and stores the received packet transmission time interval into the storage area. The interrupt issuing unit 151b preliminarily stores the packet transmission time interval to manage the scheduled transmission time. And with this structure, the interrupt issuing unit 151b can obtain the time period until the next scheduled transmission time.

The interrupt issuing unit 151b, upon receiving a packet from the packet reception unit 150b, analyzes the type of the received packet and determines whether the received packet is a realtime packet or a not-realtime packet.

When it determines that the received packet is a realtime packet, the interrupt issuing unit 151b stores the received packet into the realtime reception packet buffer 101b, and judges whether or not the time period until the scheduled transmission time is equal to or larger than the allowed time period.

When it judges that the time period until the scheduled transmission time is equal to or larger than the allowed time period, the interrupt issuing unit 151b issues an interrupt by transmitting an interrupt signal to the CPU 104b via a signal line 160b. When it judges that the time period until the scheduled transmission time is smaller than the allowed time period, the interrupt issuing unit 151b does not issue an interrupt to the CPU 104b.

When it determines that the received packet is a not-realtime packet, the interrupt issuing unit 151b stores the received packet into the not-realtime reception packet buffer 102b. The interrupt issuing unit 151b issues an interrupt by transmitting an interrupt signal to the CPU 104b via the signal line 160b after the predetermined time period (for example, 50 ms) passes since the start packet in the not-realtime reception packet buffer 102b was received, or after the number of packets stored in the not-realtime reception packet buffer 102b reaches the predetermined number (for example, 5), where the predetermined time period and the predetermined number are preliminarily stored in the interrupt issuing unit 151b.

It should be noted here that the further specific operation of the interrupt issuing unit 151b can be achieved by having and using an interrupt control unit and a timer unit that are the same as those included in the interrupt issuing unit 151, and description thereof is omitted here.

One example of the method for analyzing the type of the received packet is the same as the analysis method shown in Embodiment 1, and description thereof is omitted here.

(4-3) Packet Transmission Unit 152b

The packet transmission unit 152b receives a transmission request from the CPU 104b by receiving a transmission request signal from the CPU 104b periodically in accordance with the packet transmission time interval (for example, at an interval of 20 ms).

Upon receiving a transmission request from the CPU 104b, the packet transmission unit 152b obtains a packet from the transmission packet buffer 103b, and transmits the obtained packet via the antenna 109b.

The packet transmission unit 152b performs this transmission operation for each packet stored in the transmission packet buffer 103b.

(5) CPU 104b

The CPU 104b controls the entire network transmission/reception device 10b.

The CPU 104b outputs the packet transmission time interval to the interrupt issuing unit 151b.

Upon receiving an interrupt signal from the interrupt issuing unit 151b, the CPU 104b obtains the realtime packet stored in the realtime reception packet buffer 101b. The CPU 104b then performs a process onto the data contained in the obtained realtime packet in accordance with the type of the obtained realtime packet. The CPU 104b then obtains the one or more not-realtime packets stored in the not-realtime reception packet buffer 102b in the order. The CPU 104b then performs a process onto the data contained in the obtained not-realtime packets in accordance with the type of the obtained not-realtime packets.

The CPU 104b deletes the packets after it performs the processes thereonto. Namely, a buffer stores no packet after the CPU 104b performs processes onto all packets stored in the buffer.

As described above, the CPU 104b performs a process onto the realtime packet stored in the realtime reception packet buffer 101b, and then performs a process onto the not-realtime packets stored in the not-realtime reception packet buffer 102b. Here, in case the realtime reception packet buffer 101b does not store any packet, the CPU 104b performs a process only onto the not-realtime packets stored in the not-realtime reception packet buffer 102b; and in case the not-realtime reception packet buffer 102b does not store any packet, the CPU 104b performs a process only onto the realtime packet stored in the realtime reception packet buffer 101b.

The processes performed onto the received packets are the same as conventional ones, and detailed description thereof is omitted here.

Upon receiving audio data from the microphone 105b, the CPU 104b generates one or more transmission packets by converting the received audio data into packets, and stores the generated one or more transmission packets into the transmission packet buffer 103b.

Also, upon receiving transmission data (for example, character data) to be transmitted to the base station 20b, from the input unit 108b, the CPU 104b generates one or more transmission packets by converting the received transmission data into packets, and stores the generated one or more transmission packets into the transmission packet buffer 103b.

The technology for converting data into packets is known, and description thereof is omitted here.

Further, the CPU 104b performs transmission periodically in accordance with the packet transmission time interval (for example, at an interval of 20 ms). Here, for example, the CPU 104b periodically transmits a transmission request signal to the packet transmission unit 152b of the network chip 100b. After transmitting a transmission request signal to the packet transmission unit 152b, the CPU 104b checks on whether a realtime packet is stored in the realtime reception packet buffer 101b. When it judges that a realtime packet is stored in the realtime reception packet buffer 101b, the CPU 104b obtains the realtime packet and performs a process onto the realtime packet. The CPU 104b performs this operation for each realtime packet stored in the realtime reception packet buffer 101b.

Upon receiving an instruction regarding the operation of the network transmission/reception device 10, from the input unit 108b, the CPU 104b controls the operation of the network transmission/reception device 10 in accordance with the received instruction.

(6) Microphone 105b

The microphone 105b is the same as the microphone 105 shown in Embodiment 1, and description thereof is omitted here.

(7) Speaker 106b

The speaker 106b is the same as the speaker 106 shown in Embodiment 1, and description thereof is omitted here.

(8) Display 107b

The display 107b is the same as the display 107 shown in Embodiment 1, and description thereof is omitted here.

(9) Input Unit 108b

The input unit 108b is the same as the input unit 108 shown in Embodiment 1, and description thereof is omitted here.

2.2 Operation of Network Transmission/Reception Device 10b

(1) Operation of Interrupt Issuing Unit 151b

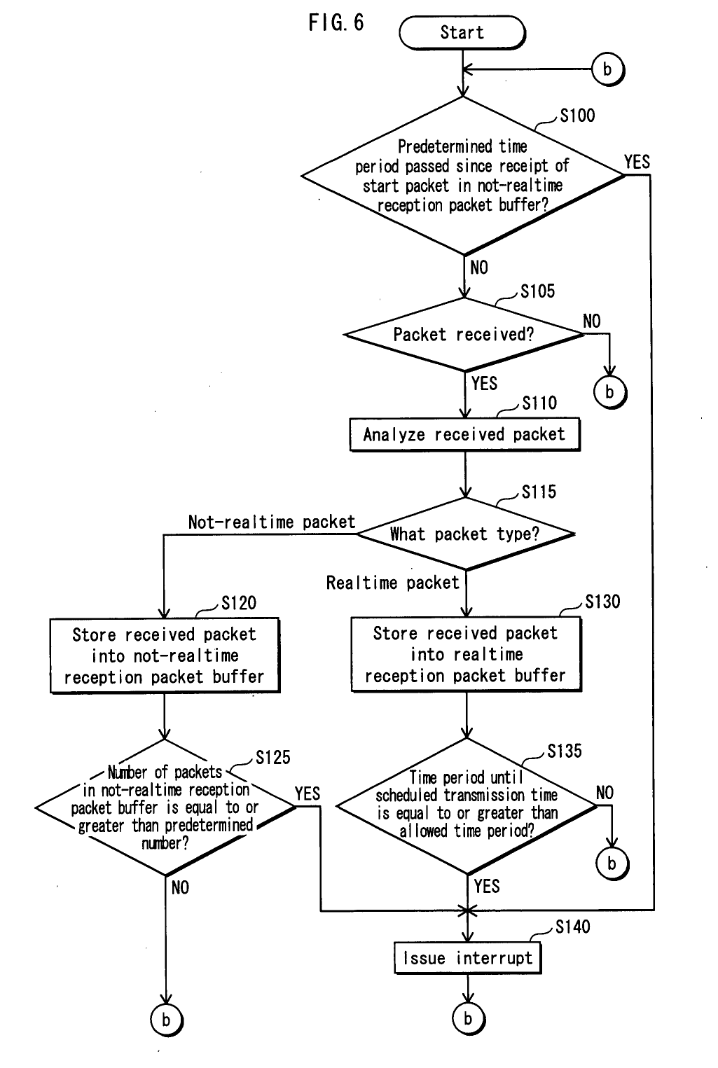

Here will be described the operation of the interrupt issuing unit 151b with reference to the flowchart shown in FIG. 6.

It is presumed here that the interrupt issuing unit 151b preliminarily stores, in the storage area, the packet transmission time interval notified from the CPU 104b and manages the scheduled transmission time.

The interrupt issuing unit 151b judges whether or not a predetermined time period has passed since receipt of the start packet in the not-realtime reception packet buffer (step S100).

When it judges that the predetermined time period has not yet passed (NO in step S100), the interrupt issuing unit 151b judges whether or not a packet has been received from the base station 20b via the packet reception unit 150b (step S105).

When it judges that a packet has not been received (NO in step S105), the interrupt issuing unit 151b returns to step S100.

When it judges that a packet has been received (YES in step S105), the interrupt issuing unit 151b analyzes the received packet (step S110), and determines the type of the received packet in accordance with the analysis result (step S115).

When it determines that the type of the received packet is not-realtime packet (“not-realtime packet” in step S115), the interrupt issuing unit 151b stores the received packet into the not-realtime reception packet buffer 102b (step S120). The interrupt issuing unit 151b then judges whether or not the number of packets in the not-realtime reception packet buffer 102b is equal to or greater than the predetermined number (step S125). When it judges that the number of packets is smaller than the predetermined number (NO in step S125), the interrupt issuing unit 151b returns to step S100. When it judges that the number of packets is equal to or greater than the predetermined number (YES in step S125), the interrupt issuing unit 151b issues an interrupt by transmitting an interrupt signal to the CPU 104b (step S140) After issuing the interrupt, the interrupt issuing unit 151b returns to step S100.

When it determines that the type of the received packet is realtime packet (“realtime packet” in step S115), the interrupt issuing unit 151b stores the received packet into the realtime reception packet buffer 101b (step S130), and judges whether or not the time period until the scheduled transmission time is equal to or larger than the allowed time period (step S135).

When it judges that the time period until the scheduled transmission time is equal to or larger than the allowed time period (YES in step S135), the interrupt issuing unit 151b issues an interrupt by transmitting an interrupt signal to the CPU 104b (step S140). After issuing the interrupt, the interrupt issuing unit 151b returns to step S100.

When it judges that the time period until the scheduled transmission time is smaller than the allowed time period (NO in step S135), the interrupt issuing unit 151b returns to step S100.

When it judges that the predetermined time period has passed (YES in step S100), the interrupt issuing unit 151b issues an interrupt by transmitting an interrupt signal to the CPU 104b (step S140). After issuing the interrupt, the interrupt issuing unit 151b returns to step S100.

(2) Operation of CPU 104b

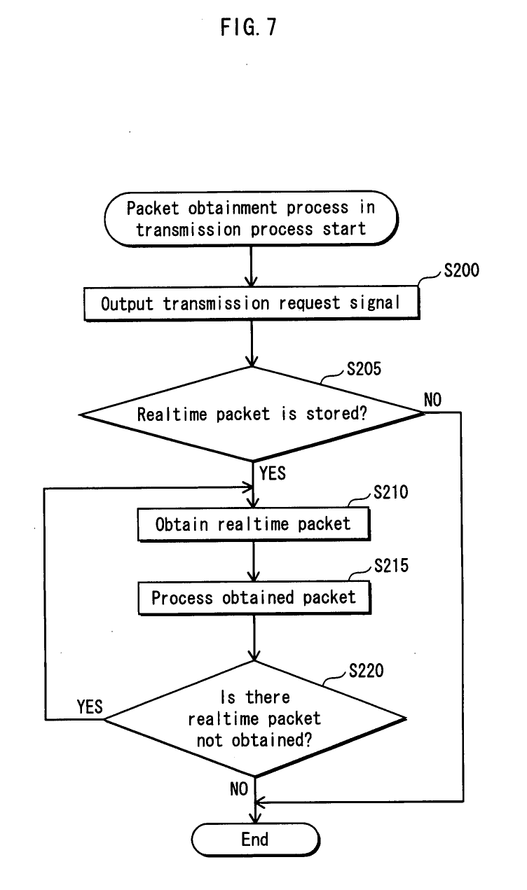

Here will be described the packet obtainment process performed by the CPU 104b in the transmission process, with reference to the flowchart shown in FIG. 7. It should be noted here that this operation is performed periodically in accordance with the packet transmission time interval.

The CPU 104b outputs the transmission request signal to the packet transmission unit 152b (step S200), and checks on whether a realtime packet is stored in the realtime reception packet buffer 101b (step S205). When it judges that a realtime packet is stored in the realtime reception packet buffer 101b (YES in step S205), the CPU 104b obtains the realtime packet (step S210), and performs a process onto the obtained realtime packet (step S215). The CPU 104b then judges whether or not there is a realtime packet, which has not been obtained, in the realtime reception packet buffer 101b (step S220).

When it judges that there is a realtime packet that has not been obtained (YES in step S220), the CPU 104b returns to step S210.

When it judges that a realtime packet is not stored in the realtime reception packet buffer 101b (NO in step S205), or when it judges that there is not a realtime packet that has not been obtained (NO in step S220), the CPU 104b ends the process.

2.3 Modification to Interrupt Issuance

In the above-described Embodiment 2, an interrupt process is performed onto the realtime packet stored in the realtime reception packet buffer 101b and an interrupt process is performed onto the one or more not-realtime packets stored in the not-realtime reception packet buffer 102b in the order at a timing when the interrupt issuing unit 151b issues an interrupt. However, the present invention is not limited to this.

These interrupt processes may be performed separately at different timings.

For example, as is the case with the medication to Embodiment 1, two signal lines may be used. Description of the detailed operation of this case is the same as that provided in the medication to Embodiment 1, and description thereof is omitted here. Alternatively, two different interrupt signals may be used.

2.4 Modification to Management of Transmission Time Interval

In the above-described Embodiment 2, the CPU 104b preliminarly outputs information of a particular transmission time pattern to the interrupt issuing unit 151b of the network chip 100b, and the interrupt issuing unit 151b manages the information of the particular transmission time pattern. However, the present invention is not limited to this.

As one example, the transmission time may be stored into the network chip, as data of history information. Then the network chip may predict the transmission time of the CPU, and judge whether or not to issue an interrupt based on the prediction result.

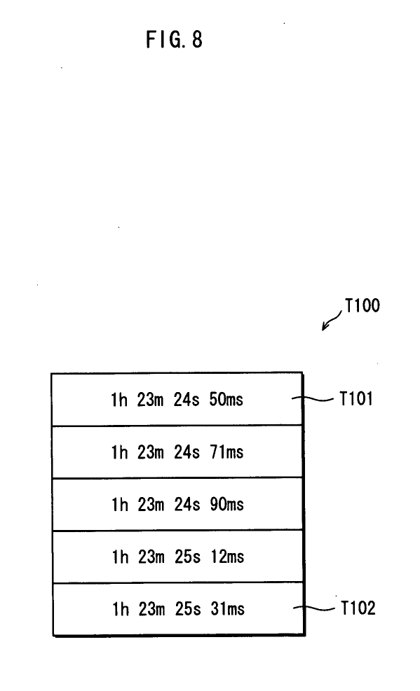

In this case, the scheduled transmission time is managed by the interrupt issuing unit 151B as follows. The interrupt issuing unit 151B stores the history data of the transmission time of the CPU. For example, as shown in FIG. 8, the interrupt issuing unit 151B has a management table T100 that holds the transmission times with respect to five packets. The management table T100 stores, as history data, transmission times of five packets in series including the most recently transmitted packet.

The interrupt issuing unit 151B refers to the history data stored in the management table T100 and detects that the interval period of the packet transmission times is approximately 20 ms. The interrupt issuing unit 151B estimates that the next scheduled transmission time is “1 h 23 m 25 s 51 ms” based on the detected interval period (20 ms).

Upon receiving a realtime packet, the interrupt issuing unit 151B judges whether or not the time period until the scheduled transmission time is equal to or larger than the allowed time period.

When it judges that the time period until the scheduled transmission time is equal to or larger than the allowed time period, the interrupt issuing unit 151B issues an interrupt by transmitting an interrupt signal to the CPU. When it judges that the time period until the scheduled transmission time is smaller than the allowed time period, the interrupt issuing unit 151B does not issue an interrupt to the CPU. With this structure, it is possible to reduce the number of interrupts.

2.5 Other Modifications

Up to now, the present invention has been described through Embodiment 2. However, the present invention is not limited to the embodiment, but includes, for example, the following modifications.

(1) In Embodiment 2 described above, a radio transmission path is used to transmit/receive a packet. However, a wired transmission path may be used instead.

(2) As a modification to Embodiment 2 described above, the allowed time period may be such a time period that is equal to or smaller than a delay time allowed to each realtime packet by the network transmission/reception device.

(3) In Embodiment 2 described above, the network transmission/reception device receives realtime packets and not-realtime packets. However, the present invention is not limited to this.

The network transmission/reception device may receive only realtime packets.

As described in Embodiment 2, when the network transmission/reception device transmits periodically, and when it judges, after receiving a realtime packet, that the time period until the scheduled transmission time is smaller than a predetermined time period, it may not issue an interrupt, but the CPU, when it transmits, may check on the realtime packet reception packet buffer and obtain a realtime packet therefrom. This is effective in reducing the number of interrupts with respect to the CPU.

(4) In Embodiment 2 described above, a periodical transmission time pattern is provided as an example of the predetermined transmission time pattern. However, not limited to this, any other transmission time patterns may be used.

(5) In Embodiment 2 described above, when the CPU performs the transmission process, it checks on the realtime packet reception packet buffer, and when the buffer stores a realtime packet, it obtains the realtime packet therefrom and processes the realtime packet. However, the present invention is not limited to this.

The following shows another example.

When the CPU performs the transmission process, it may check on both the realtime packet reception packet buffer and the not-realtime packet reception packet buffer.

In this case, the CPU first checks on the realtime packet reception packet buffer, and when the buffer stores a realtime packet, it obtains the realtime packet therefrom and processes the realtime packet. When no realtime packet is stored in the buffer, or when all realtime packets have been processed, the CPU checks on the not-realtime packet reception packet buffer, and when the buffer stores a not-realtime packet, it obtains the not-realtime packet therefrom and processes the not-realtime packet.

In Embodiment 2 described above, an interrupt is not issued until the number of not-realtime packets stored in the not-realtime reception packet buffer reaches the predetermined number, or until the predetermined time period passes since the receipt of the start packet in the not-realtime reception packet buffer. However, when the CPU performs the transmission process before an interrupt occurs, and when the CPU obtains a reception packet from the not-realtime reception packet buffer, an interrupt for the not-realtime packets that have been obtained so far becomes unnecessary.

The following shows further another example.

The present invention may be applied to a network transmission/reception device that receives only not-realtime packets.

In this case, when the CPU performs the transmission process, it checks on the not-realtime packet reception packet buffer, and when the buffer stores a not-realtime packet, it obtains the not-realtime packet therefrom and processes the not-realtime packet.

(6) The present invention may be any combination of the above-described embodiment and modifications.

2.6 Summary

With the above-described structure of Embodiment 2, it is possible to reduce the number of interrupts while obeying the restriction to the delay time of the realtime packets, by setting an allowed delay time, namely allowing that a realtime packet is delayed for a predetermined time period in the network chip.

Further, when realtime packets that are restricted in delay time are received and when a transmission having a predetermined transmission time pattern is performed, the following is possible. That is to say, when a realtime packet is received and the time period until the scheduled transmission time is smaller than a predetermined allowed time period, an interrupt is not issued, and when the CPU performs the transmission process, it checks on the realtime packet reception packet buffer to obtains a realtime packet. This structure enables the number of interrupts associated with the reception of the realtime packets to be reduced.

### 3. Embodiment 3

A transmission/reception system 1c as another preferred embodiment of the present invention will be described in the following, with reference to the attached drawings.

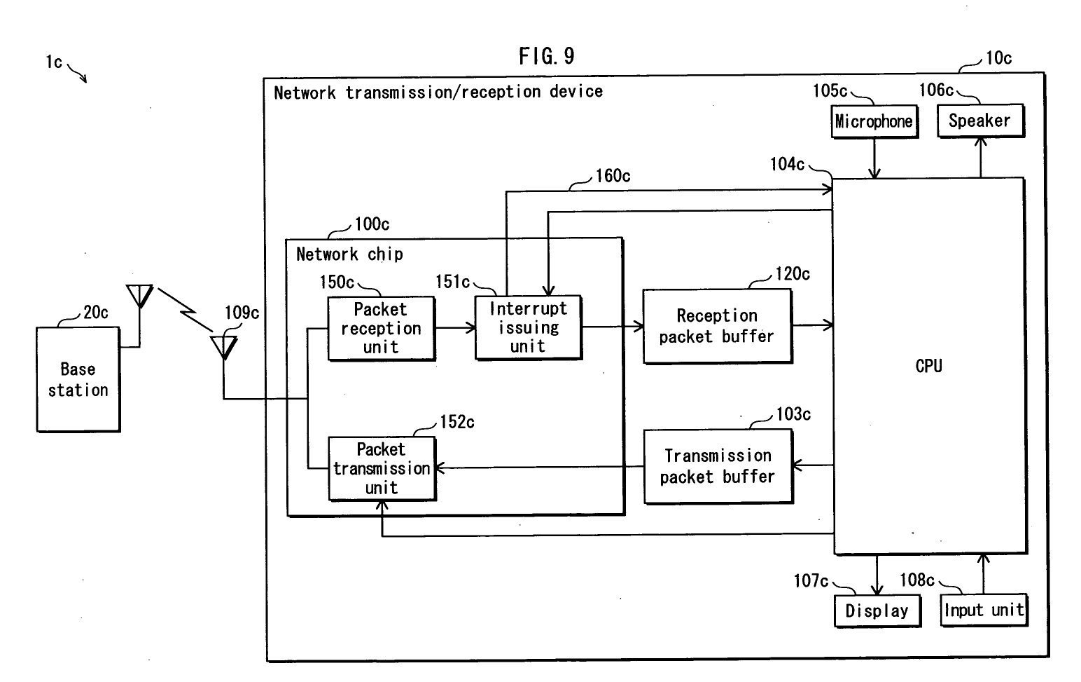

The transmission/reception system 1c, as shown in FIG. 9, includes a network transmission/reception device 10c and a base station 20c.

The network transmission/reception device 10c and the base station 20c perform a network communication therebetween by transmitting/receiving packets using a radio transmission path.

The packets that the network transmission/reception device 10c receives from the base station 20c are restricted to the not-realtime packets.

The present embodiment discloses a technology for reducing the interrupts when the network transmission/reception device 10c is connected to the base station 20c over a network and when a connection in the application level is not performed (for example, when a mobile phone is in the standby mode).

Here, being connected via a network indicates that the network transmission/reception device (STA) 10c is connected to the base station (AP) 20c in the MAC level, namely, in the 802.11 radio LAN. In such a case, the STA receives the beacon that is transmitted periodically from the AP. The beacon contains various types of information concerning the current network, and is a type of not-realtime packet. In the following description, the beacon is also referred to as a beacon packet.

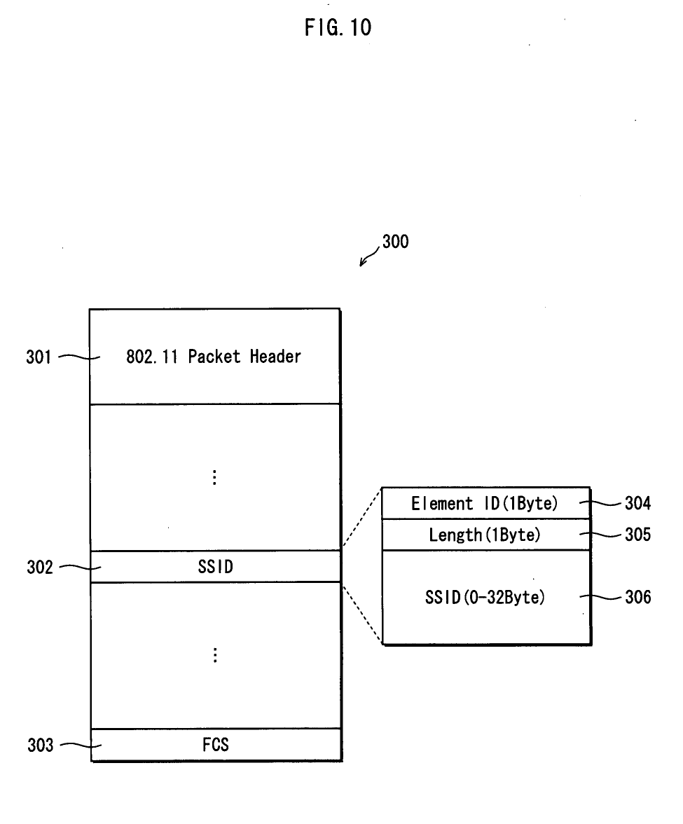

FIG. 10 shows a beacon packet format 300 indicating the data structure of the beacon packet. When it is connected to the base station 20c, the network transmission/reception device 10c periodically receives the beacon packet shown in the beacon packet format 300.

The beacon packet format 300 includes an 802.11 packet header 301, an SSID 302, and an FCS (Flame Check Sequence) 303. It should be noted here that the definition of data for use in the 802.11 packet header 301, SSID 302, and FCS (Flame Check Sequence) 303 is known, and description thereof is omitted here. The following describes the SSID 302 briefly.

The SSID 302, as shown in FIG. 10, includes an element ID 304, a length 305, and an SSID 306. The element ID 304 and the length 305 are respectively 1-byte data. The SSID 306 is a network identifier composed of up to 32 bytes of data.

In the 802.11 network, when the network transmission/reception device 10c and the base station 20c are connected to each other only by the network connection, a TCP/UDP (Transmission Control Protocol/User Datagram Protocol) packet is transmitted from the base station 20c to the network transmission/reception device 10c as an application packet, while the TCP/UDP packet is capsuled in an 802.11 packet.

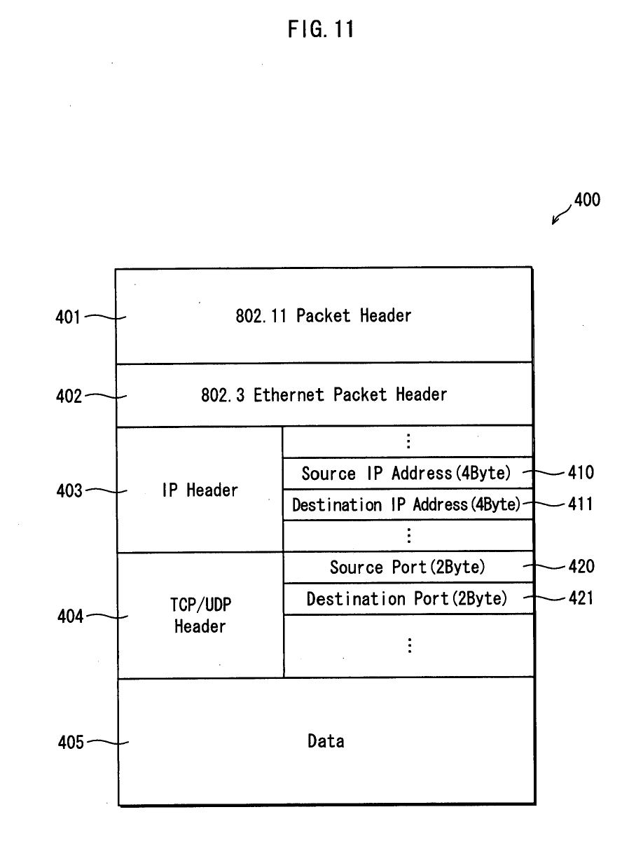

FIG. 11 shows an application packet format 400 indicating the data structure of the application-packet.

The application packet format 400 includes an 802.11 packet header 401, an 802.3 Ethernet packet header 402, an IP header 403, a TCP/UDP header 404, and data 405.

The IP header 403 is an IP packet and includes a source IP address 410 and a destination IP address 411. Each of the source IP address 410 and destination IP address 411 is 4-byte data.

The TCP/UDP header 404 is a TCP/UDP packet and includes a source port 420 and a destination port 421. Each of the source port 420 and a destination port 421 is 2-byte data. The data stored in the destination port 421 is a port number that indicates a type of an application in the application level.

As described above, the application packet format 400 indicates a packet that is generated by capsuling the TCP/UDP header 404 (TCP/UDP packet) in the IP header 403 (IP packet), and further capsuling it in an 802.11 packet. The type of the application in the application level can be identified by the port number (destination port) in the TCP/UDP packet level.

The following will describe the structure and operation of the network transmission/reception device 10c.

3.1 Structure of Network Transmission/Reception Device 10c

The network transmission/reception device 10c, as shown in FIG. 9, includes a network chip 100c, a reception packet buffer 120c, a transmission packet buffer 103c, a CPU 104c, a microphone 105c, a speaker 106c, a display 107c, an input unit 108c, and an antenna 109c.

It is presumed here that the data input/output between the CPU 104c and each of the microphone 105c, the speaker 106c, the display 107c, and the input unit 108c is performed via a bus (not illustrated).

(1) Reception Packet Buffer 120c

The reception packet buffer 120c has an area for storing one or more received not-realtime packets.

It is presumed here that the size of the area of the reception packet buffer 120c is large enough to store one or more received packets.

(2) Transmission Packet Buffer 103c

The transmission packet buffer 103c has the same structure as the transmission packet buffer 103 shown in Embodiment 1, and description thereof is omitted here.

(3) Network Chip 100c

The network chip 100c, as shown in FIG. 9, includes a packet reception unit 150c, an interrupt issuing unit 151c, and a packet transmission unit 152c.

The network chip 100c receives a packet from the base station 20c via the antenna 109c, and analyzes the received packet. The network chip 100c determines whether or not to issue an interrupt to the CPU 104c in accordance with the analysis result of the received packet, and performs a control according to the determination.

Further, the network chip 100c transmits packets periodically to the base station 20c via the antenna 109c.

(3-1) Packet Reception Unit 150c

The packet reception unit 150c, upon receiving a packet from the base station 20c via the antenna 109c, outputs the received packet to the interrupt issuing unit 151c.

(3-2) Interrupt Issuing Unit 151c

The interrupt issuing unit 151c has a storage area for storing a port number that indicates an application specified by the CPU 104c.

The interrupt issuing unit 151c receives, from the CPU 104c when the CPU 104c starts to sleep, a port number that indicates an application specified by the CPU 104c, and then stores the received port number in the storage area. For example, the interrupt issuing unit 151c receives, from the CPU 104c, a port number that indicates a call control for a voice conversation as an application specified by the CPU 104c, and then stores the received port number in the storage area. With this, the network transmission/reception device 10c enters the standby mode.

The interrupt issuing unit 151c, upon receiving a packet from the packet reception unit 150c, analyzes the received packet.

The interrupt issuing unit 151c determines whether the received packet is a beacon packet or an application packet according to the analysis result.

When it determines that the received packet is an application packet, the interrupt issuing unit 151c further judges whether the received packet is a packet of the application specified by the CPU 104c. In the present example, the interrupt issuing unit 151c makes the judgment on whether the received packet is a packet of the application specified by the CPU 104c, based on whether the port number stored in the storage area matches the port number indicated by the destination port 421 included in the received application packet.

When it judges that the received packet is a packet of the application specified by the CPU 104c, namely, when it judges that the port number stored in the storage area matches the port number indicated by the destination port 421 included in the received application packet, the interrupt issuing unit 151c stores the received packet into the reception packet buffer 120c, and issues an interrupt by transmitting an interrupt signal to the CPU 104c via the signal line 160c.

When it judges that the received packet is a beacon packet or when it judges that the received packet is not a packet of the application specified by the CPU 104c, the interrupt issuing unit 151c discards the received packet.

For example, the interrupt issuing unit 151c issues an interrupt to the CPU 104c only when the port number indicated by the destination port 421 included in the received application packet is a port number that indicates a call control for a voice conversation, namely, only when an application packet associated with the call control is received.

(3-3) Packet Transmission Unit 152c

The packet transmission unit 152c has the same structure as the packet transmission unit 152 shown in Embodiment 1, and description thereof is omitted here.

(4) CPU 104c

The CPU 104c controls the entire network transmission/reception device 10c.

The CPU 104c changes the operation mode to the sleep mode after outputting a port number (for example, a port number indicating a call control for a voice conversation) of an application, which becomes a trigger for issuing an interrupt, to the interrupt issuing unit 151c.

Upon receiving an interrupt signal from the interrupt issuing unit 151c, the CPU 104c obtains a packet (application packet of the application specified by the CPU 104c) stored in the reception packet buffer 120c. The CPU 104c performs a process onto the data contained in the obtained packet.

The CPU 104c deletes the packets after it performs the processes thereonto. Namely, a buffer stores no packet after the CPU 104c performs processes onto all packets stored in the buffer.

The processes performed onto the received packets are the same as conventional ones, and detailed description thereof is omitted here.

Upon receiving audio data from the microphone 105c, the CPU 104c generates one or more transmission packets by converting the received audio data into packets, and stores the generated one or more transmission packets into the transmission packet buffer 103c.

Also, upon receiving transmission data (for example, character data) to be transmitted to the base station 20c, from the input unit 108c, the CPU 104c generates one or more transmission packets by converting the received transmission data into packets, and stores the generated one or more transmission packets into the transmission packet buffer 103c.

When it starts to transmit a transmission packet, the CPU 104c transmits a transmission request signal to the packet transmission unit 152c.

The technology for converting data into packets is known, and description thereof is omitted here.

Further, upon receiving an instruction regarding the operation of the network transmission/reception device 10c, from the input unit 108c, the CPU 104c. controls the operation of the network transmission/reception device 10c in accordance with the received instruction.

(5) Microphone 105c

The microphone 105c is the same as the microphone 105 shown in Embodiment 1, and description thereof is omitted here.

(6) Speaker 106c

The speaker 106c is the same as the speaker 106 shown in Embodiment 1, and description thereof is omitted here.

(7) Display 107c

The display 107c is the same as the display 107 shown in Embodiment 1, and description thereof is omitted here.

(8) Input Unit 108c

The input unit 108c is the same as the input unit 108 shown in Embodiment 1, and description thereof is omitted here.

3.2 Operation of Network Transmission/Reception Device 10c

(1) Operation of Interrupt Issuing Unit 151c

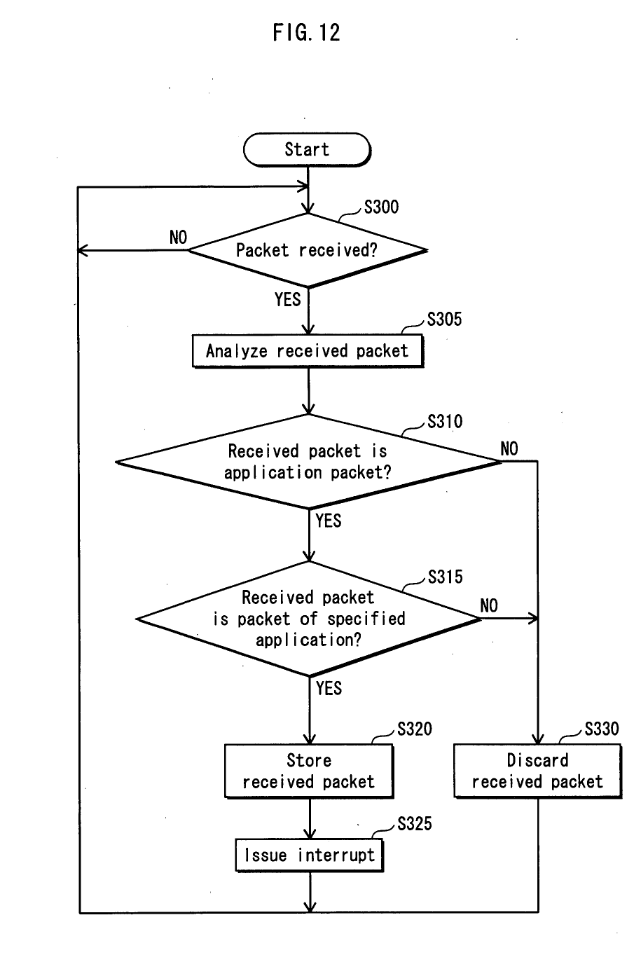

Here, the operation of the interrupt issuing unit 151c will be described with reference to the flowchart shown in FIG. 12.

It is presumed here that the interrupt issuing unit 151c preliminarily stores, in the storage area, the port number of the application specified by the CPU 104c.

The interrupt issuing unit 151c judges whether a packet has been received from the base station 20c via the packet reception unit 150c (step S300).

When it judges that a packet has not been received (NO in step S300), the interrupt issuing unit 151c returns to step S300.

When it judges that a packet has been received (YES in step S300), the interrupt issuing unit 151c analyzes the received packet (step S305), and determines whether the received packet is an application packet (step S310), in accordance with the analysis result.

When it judges that the received packet is an application packet (YES in step S310), the interrupt issuing unit 151c judges whether the received packet is a packet of the application specified by the CPU 104c (step S315).

When it judges that the received packet is a packet of the application specified by the CPU 104c (YES in step S315), the interrupt issuing unit 151c stores the received-packet (step S320). The interrupt issuing unit 151c then issues an interrupt by transmitting an interrupt signal to the CPU 104c (step S325). After issuing the interrupt, the interrupt issuing unit 151c returns to step S300.

When it judges that the received packet is not an application packet, namely, when it judges that the received packet is a beacon packet (NO in step S310), or when it judges that the received packet is not a packet of the application specified by the CPU 104c (NO in step S315), the interrupt issuing unit 151c discards the received packet (step S330), and returns to step S300.

3.3 Modifications

Up to now, the present invention has been described through Embodiment 3. However, the present invention is not limited to the embodiment, but includes, for example, the following modifications.

(1) In Embodiment 3 described above, a radio transmission path is used to transmit/receive a packet. However, a wired transmission path may be used instead.

(2) In Embodiment 3 described above, the interrupt issuing unit 151c discards a received packet when the received packet is a beacon packet or when the received packet is not a packet of the application specified by the CPU 104c. However, the present invention is not limited to this.

When the received packet is a beacon packet or, when the received packet is not a packet of the application specified by the CPU 104c, the interrupt issuing unit 151c may store the received packet into the reception packet buffer 120c.

In this case, an interrupt is issued when a packet of the application specified by the CPU 104c is received and stored.

(3) The present invention may be any combination of the above-described embodiment and modifications.

3.4 Summary

With the above-described structure of Embodiment 3, when the network chip is connected to the network but is not connected in an application level, the network chip analyzes and identifies the received packet in the application level, and issues an interrupt to the CPU only when the received packet is a packet of an application specified by the CPU. This structure reduces the number of interrupts and thereby achieves a power-saving network transmission/reception device.

### 4. Embodiment 4

A transmission/reception system 1d as another preferred embodiment of the present invention will be described in the following, with reference to the attached drawings.

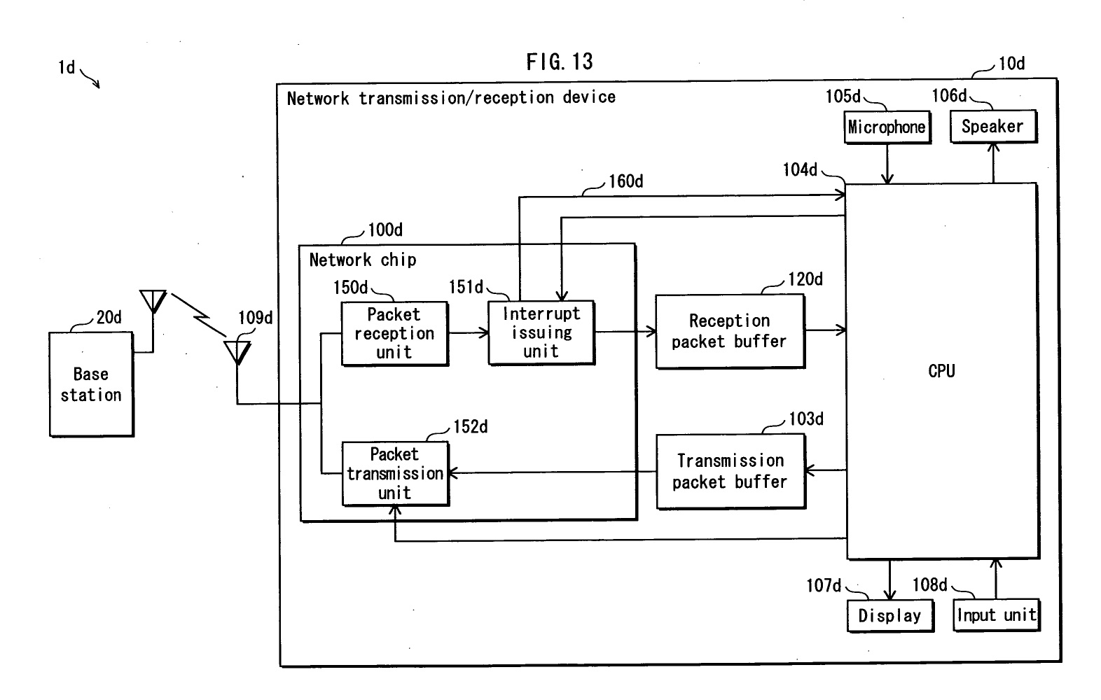

The transmission/reception system 1d, as shown in FIG. 13, includes a network transmission/reception device 10d and a base station 20d.

The network transmission/reception device 10d and the base station 20d perform a network communication therebetween by transmitting/receiving packets using a radio transmission path.

The packets that the network transmission/reception device 10d receives from the base station 20d are restricted to the not-realtime packets.

The present embodiment discloses a technology for reducing the interrupts when a network connection is not made.

The base station 20d transmits beacon packets to a particular network among a plurality of networks. The data structure of the beacon packet is the same as that shown in FIG. 10, and description thereof is omitted here. In the following description, the beacon packet format 300 will be cited if a reference to the beacon packet is required.

When a network connection is not made, the network transmission/reception device 10d does not receive a beacon packet from the base station 20d. This state corresponds to, for example, a case where a mobile phone is out of range.

The following will describe the structure and operation of the network transmission/reception device 10d.

4.1 Structure of Network Transmission/Reception Device 10d

The network transmission/reception device 10d, as shown in FIG. 13, includes a network chip 100d, a reception packet buffer 120d, a transmission packet buffer 103d, a CPU 104d, a microphone 105d, a speaker 106d, a display 107d, an input unit 108d, and an antenna 109d.

It is presumed here that the data input/output between the CPU 104d and each of the microphone 105d, the speaker 106d, the display 107d, and the input unit 108d is performed via a bus (not illustrated).

(1) Reception Packet Buffer 120d

The reception packet buffer 120d is the same as the reception packet buffer 120c shown in Embodiment 3, and description thereof is omitted here.

(2) Transmission Packet Buffer 103d

The transmission packet buffer 103d is the same as the transmission packet buffer 103 shown in Embodiment 1, and description thereof is omitted here.

(3) Network Chip 100d

The network chip 100d, as shown in FIG. 13, includes a packet reception unit 150d, an interrupt issuing unit 151d, and a packet transmission unit 152d.

The network chip 100d receives a packet from the base station 20d via the antenna 109d, and analyzes the received packet. The network chip 100d determines whether or not to issue an interrupt to the CPU 104d in accordance with the analysis result of the received packet, and performs a control according to the determination.

Further, the network chip 100d transmits packets to the base station 20d via the antenna 109d.

(3-1) Packet Reception Unit 150d

The packet reception unit 150d, upon receiving a packet from the base station 20d via the antenna 109d, outputs the received packet to the interrupt issuing unit 151d.

(3-2) Interrupt Issuing Unit 151d

The interrupt issuing unit 151d has a storage area for storing an identifier for identifying a network specified by the CPU 104d. Here, the identifier for identifying a network is data that is used for the SSID 306 included in the beacon packet format 300.

The interrupt issuing unit 151d receives, from the CPU 104d when the CPU 104d starts to sleep, an identifier for identifying a network specified by the CPU 104d, and then stores the received network identifier into the storage area.

The interrupt issuing unit 151d, upon receiving a packet from the packet reception unit 150d, analyzes the received packet. In the present example; the interrupt issuing unit 151d obtains the SSID that is contained in the received packet.

The interrupt issuing unit 151d determines whether or not the received packet is a beacon packet of the network specified by the CPU 104d, in accordance with the analysis result. Here, the interrupt issuing unit 151d determines it based on whether the identifier stored in the storage area matches the identifier indicated by the SSID 306 included in the received beacon packet.

When it judges that the received packet is a beacon packet of the network specified by the CPU 104d, namely, that the identifier stored in the storage area matches the identifier indicated by the SSID 306 included in the received beacon packet, the interrupt issuing unit 151d stores the received packet into the reception packet buffer 120d, and issues an interrupt by transmitting an interrupt signal to the CPU 104d via the signal line 160d.

When it judges that the received packet is not a beacon packet of the network specified by the CPU 104d, the interrupt issuing unit 151d discards the received packet.

(3-3) Packet Transmission Unit 152d

The packet transmission unit 152d is the same as the packet transmission unit 152 shown in Embodiment 1, and description thereof is omitted here.

(4) CPU 104d

The CPU 104d controls the entire network transmission/reception device 10d.

The CPU 104d changes the operation mode to the sleep mode after outputting a network identifier, which becomes a trigger for issuing an interrupt, to the interrupt issuing unit 151d.

Upon receiving an interrupt signal from the interrupt issuing unit 151d, the CPU 104d obtains a packet (beacon packet of the network specified by the CPU 104d) stored in the reception packet buffer 120d. The CPU 104d performs a process onto the data contained in the obtained packet.

The CPU 104d deletes the packets after it performs the processes thereonto. Namely, a buffer stores no packet after the CPU 104d performs processes onto all packets stored in the buffer.

The processes performed onto the received packets are the same as conventional ones, and detailed description thereof is omitted here.

Upon receiving audio data from the microphone 105d, the CPU 104d generates one or more transmission packets by converting the received audio data into packets, and stores the generated one or more transmission packets into the transmission packet buffer 103d.

Also, upon receiving transmission data (for example, character data) to be transmitted to the base station 20d, from the input unit 108d, the CPU 104d generates one or more transmission packets by converting the received transmission data into packets, and stores the generated one or more transmission packets into the transmission packet buffer 103d.

When it starts to transmit a transmission packet, the CPU 104d transmits a transmission request signal to the packet transmission unit 152d.

The technology for converting data into packets is known, and description thereof is omitted here.

Further, upon receiving an instruction regarding the operation of the network transmission/reception device 10d, from the input unit 108d, the CPU 104d controls the operation of the network transmission/reception device 10d in accordance with the received instruction.

(5) Microphone 105d

The microphone 105d is the same as the microphone 105 shown in Embodiment 1, and description thereof is omitted here.

(6) Speaker 106d

The speaker 106d is the same as the speaker 106 shown in Embodiment 1, and description thereof is omitted here.

(7) Display 107d

The display 107d is the same as the display 107 shown in Embodiment 1, and description thereof is omitted here.

(8) Input Unit 108d

The input unit 108d is the same as the input unit 108 shown in Embodiment 1, and description thereof is omitted here.

4.2 Operation of Network Transmission/Reception Device 10d

(1) Operation of Interrupt Issuing Unit 151d

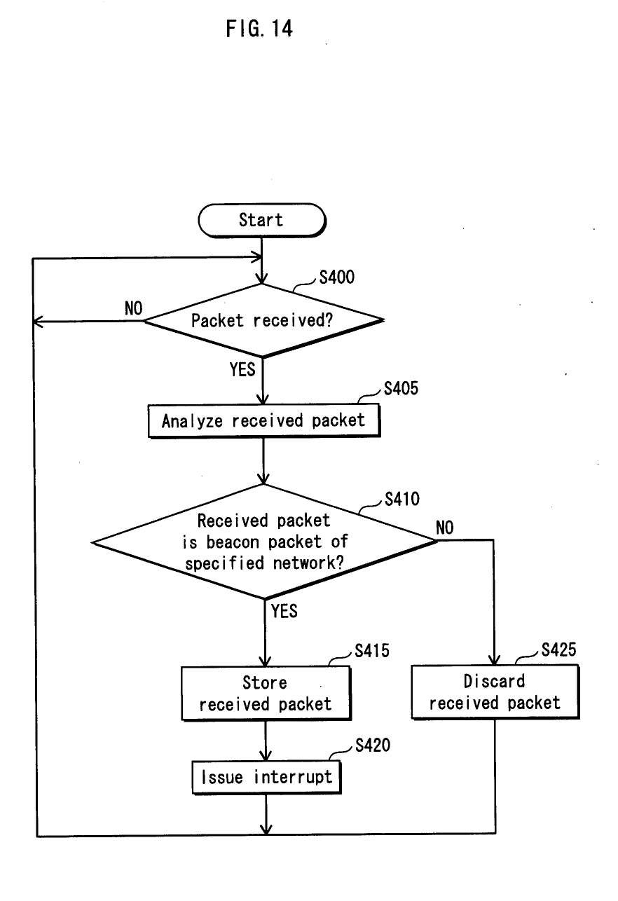

Here, the operation of the interrupt issuing unit 151d will be described with reference to the flowchart shown in FIG. 14.

It is presumed here that the interrupt issuing unit 151d preliminarily stores, in the storage area, the identifier of the network specified by the CPU 104d.

The interrupt issuing unit 151d judges whether a packet has been received from the base station 20d via the packet reception unit 150d (step S400).

When it judges that a packet has not been received (NO in step S400), the interrupt issuing unit 151d returns to step S400.

When it judges that a packet has been received (YES in step S400), the interrupt issuing unit 151d analyzes the received packet (step S405), and determines whether the received packet is a beacon packet of the network specified by the CPU 104d (step S410), in accordance with the analysis result.

When it judges that the received packet is a beacon packet of the network specified by the CPU 104d (YES in step S410), the interrupt issuing unit 151d stores the received beacon packet into the reception packet buffer 120d (step S415). The interrupt issuing unit 151d then issues an interrupt by transmitting an interrupt signal to the CPU 104d (step S420). After issuing the interrupt, the interrupt issuing unit 151d returns to step S400.

When it judges that the received packet is not a beacon packet of the network specified by the CPU 104d (NO instep S410), the interrupt issuing unit 151d discards the received packet (step S425), and returns to step S400.

4.3 Modifications

Up to now, the present invention has been described through Embodiment 4. However, the present invention is not limited to the embodiment, but includes, for example, the following modifications.

(1) In Embodiment 4 described above, a radio transmission path is used to transmit/receive a packet. However, a wired transmission path may be used instead.

(2) The present invention may be any combination of the above-described embodiment and modifications.

4.4 Summary

With the above-described structure of Embodiment 4, it is possible to reduce the number of interrupts issued to the CPU when a network connection is not made, and thereby achieve a power-saving network transmission/reception device.

### 5. Embodiment 5

A transmission/reception system 1e as another preferred embodiment of the present invention will be described in the following, with reference to the attached drawings.

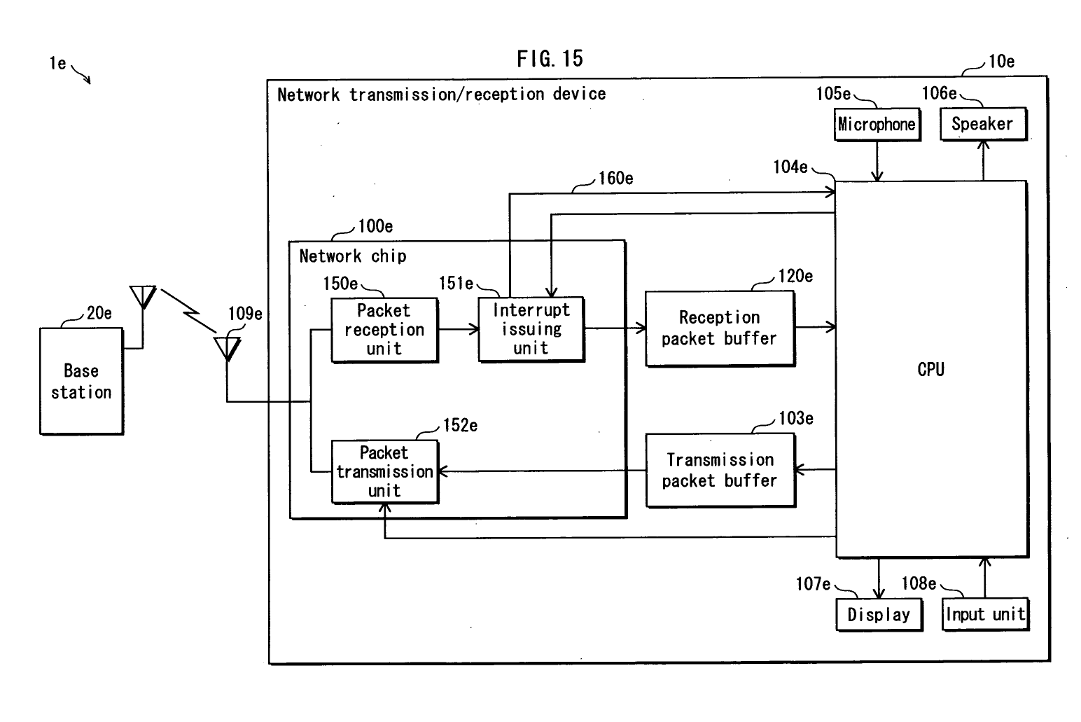

The transmission/reception system 1e, as shown in FIG. 15, includes a network transmission/reception device 10e and a base station 20e.

The network transmission/reception device be and the base station 20e perform a network communication therebetween by transmitting/receiving packets using a radio transmission path.

The packets that the network transmission/reception device 10e receives from the base station 20e are restricted to the not-realtime packets.

In the present embodiment, during a normal operation, the network transmission/reception device, more specifically, the network chip thereof checks whether a received packet is a packet destined for the own device, and only when it judges that the received packet is a packet destined for the own device, it issues an interrupt. This reduces the number of interrupts issued to the CPU.

It is presumed here that the packets transmitted/received are ARP packets or TCP/UDP packets of the application packet format 400.

Each TCP/UDP packet is composed of the IP header 403, TCP/UDP header 404, and data 405 shown in FIG. 11.

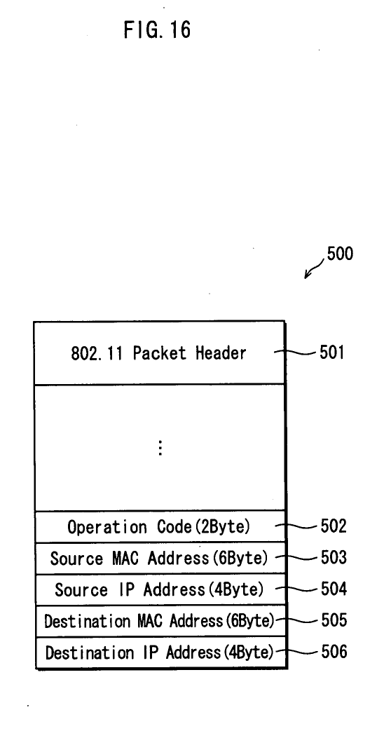

The following will describe the ARP packet with reference to FIG. 16.

FIG. 16 shows an ARP packet format 500 indicating the data structure of the ARP packet.

The ARP packet format 500 includes an 802.11 packet header 501, an operation code 502, a source MAC address 503, a source IP address 504, a destination MAC address 505, and a destination IP address 506. It should be noted here that the definition of data for use in the 802.11 packet header 501, operation code 502, source MAC address 503, source IP address 504, destination MAC address 505, and destination IP address 506 is known, and detailed description thereof is omitted here.

The operation code 502 is 2-byte data. The source MAC address 503 and destination MAC address 505 are 6-byte data. The source IP address 504 and destination IP address 506 are 4-byte data.

The ARP packet shown in the ARP packet format 500 is a packet used to obtain a MAC address from an IP address. For example, when the base station 20e needs to obtain a MAC address of a certain network transmission/reception device, the base station 20e transmits an ARP request packet having data that indicates the following.

Operation code: “request”

Source MAC address: “MAC address of own terminal”

Source IFI address: “IP address of own terminal”

Destination MAC address: “broadcast address”

Destination IP address: “IP address of terminal whose MAC address is to be obtained”

Upon receiving the above-indicated ARP request packet, the network transmission/reception device, after confirming that the IP address of the own device matches the destination IP address specified in the ARP request packet, transmits an ARP response packet having data that indicates the following.

Operation code: “response”

Source MAC address: “MAC address of own terminal”

Source IP address: “IP address of own terminal”

Destination MAC address: “MAC address of remote terminal”

Destination IP address: “IP address of remote terminal”

By transmitting the above-indicated ARP request packet and receiving the above-indicated ARP response packet, the base station 20e can obtain a MAC address of a network transmission/reception device having a certain IP address, and thus can perform a communication with the device using the MAC address in conformance with the 802.11 or Ethernet.

The following will describe the structure and operation of the network transmission/reception device 10e.

It is presumed here, as described above, that the packets received by the network transmission/reception device 10e are TCP/UDP packets or ARP packets.

5.1 Structure of Network Transmission/Reception Device

The network transmission/reception device 10e, as shown in FIG. 15, includes a network chip 100e, a reception packet buffer 120e, a transmission packet buffer 103e, a CPU 104e, a microphone 105e, a speaker 106e, a display 107e, an input unit 108e, and an antenna 109e.

It is presumed here that the data input/output between the CPU 104e and each of the microphone 105e, the speaker 106e, the display 107e, and the input unit 108e is performed via a bus (not illustrated).

(1) Reception Packet Buffer 120e

The reception packet buffer 120e is the same as the reception packet buffer 120c shown in Embodiment 3, and description thereof is omitted here.

(2) Transmission Packet Buffer 103e

The transmission packet buffer 103e is the same as the transmission packet buffer 103 shown in Embodiment 1, and description thereof is omitted here.

(3) Network Chip 100e

The network chip 100e, as shown in FIG. 15, includes a packet reception unit 150e, an interrupt issuing unit 151e, and a packet transmission unit 152e.

The network chip 100e receives a packet (TCP/UDP packet or ARP packet) from the base station 20e via the antenna 109e, and analyzes the received packet. The network chip 100e determines whether or not to issue an interrupt to the CPU 104e in accordance with the analysis result of the received packet, and performs a control according to the determination.

Further, the network chip 100e transmits packets to the base station 20e via the antenna 109e.

(3-1) Packet Reception Unit 150e

The packet reception unit 150e, upon receiving a packet (TCP/UDP packet or ARP packet) from the base station 20e via the antenna 109e, outputs the received packet to the interrupt issuing unit 151e.

(3-2) Interrupt Issuing Unit 151e

The interrupt issuing unit 151e has a storage area for storing an IP address identifier of the own device.

The interrupt issuing unit 151e receives an IP address of the own device from the CPU 104e, and stores the received IP address into the storage area.

The interrupt issuing unit 151e, upon receiving a packet from the packet reception unit 150e, analyzes the received packet. In the present example, the interrupt issuing unit 151e obtains the IP address that is contained in the received packet.

The interrupt issuing unit 151e determines whether or not the received packet is a packet destined for the own device, in accordance with the analysis result. Here, the interrupt issuing unit 151e determines it based on whether the IP address stored in the storage area matches the IP address indicated by the destination IP address contained in the received packet (TCP/UDP packet or ARP packet).

When it judges that the received packet is a packet destined for the own device, namely, that the IP address stored in the storage area matches the IP address indicated by the destination IP address contained in the received packet, the interrupt issuing unit 151e stores the received packet into the reception packet buffer 120e, and issues an interrupt by transmitting an interrupt signal to the CPU 104e via the signal line 160e.

When it judges that the received packet is not a packet destined for the own device, the interrupt issuing unit 151e discards the received packet.

(3-3) Packet Transmission Unit 152e

The packet transmission unit 152e is the same as the packet transmission unit 152 shown in Embodiment 1, and description thereof is omitted here.

(4) CPU 104e

The CPU 104e controls the entire network transmission/reception device 10e.

The CPU 104e outputs the IP address of the own device to the interrupt issuing unit 151e.

Upon receiving an interrupt signal from the interrupt issuing unit 151e, the CPU 104e obtains a packet stored in the reception packet buffer 120e. The CPU 104e performs a process onto the data contained in the obtained packet.

The CPU 104e deletes the packets after it performs the processes thereonto. Namely, a buffer stores no packet after the CPU 104e performs processes onto all packets stored in the buffer.

The processes performed onto the received packets are the same as conventional ones, and detailed description thereof is omitted here.

Upon receiving audio data from the microphone 105e, the CPU 104e generates one or more transmission packets by converting the received audio data into packets, and stores the generated one or more transmission packets into the transmission packet buffer 103e.

Also, upon receiving transmission data (for example, character data) to be transmitted to the base station 20e, from the input unit 108e, the CPU 104e generates one or more transmission packets by converting the received transmission data into packets, and stores the generated one or more transmission packets into the transmission packet buffer 103e.

When it starts to transmit a transmission packet, the CPU 104e transmits a transmission request signal to the packet transmission unit 152e.

The technology for converting data into packets is known, and description thereof is omitted here.

Further, upon receiving an instruction regarding the operation of the network transmission/reception device 10e, from the input unit 108e, the CPU 104e controls the operation of the network transmission/reception device 10e in accordance with the received instruction.

(5) Microphone 105e

The microphone 105e is the same as the microphone 105 shown in Embodiment 1, and description thereof is omitted here.

(6) Speaker 106e

The speaker 106e is the same as the speaker 106 shown in Embodiment 1, and description thereof is omitted here.

(7) Display 107e

The display 107e is the same as the display 107 shown in Embodiment 1, and description thereof is omitted here.

(8) Input Unit 108e

The input unit 108e is the same as the input unit 108 shown in Embodiment 1, and description thereof is omitted here.

5.2 Operation of Network Transmission/Reception Device 10e

(1) Operation of Interrupt Issuing Unit 151e

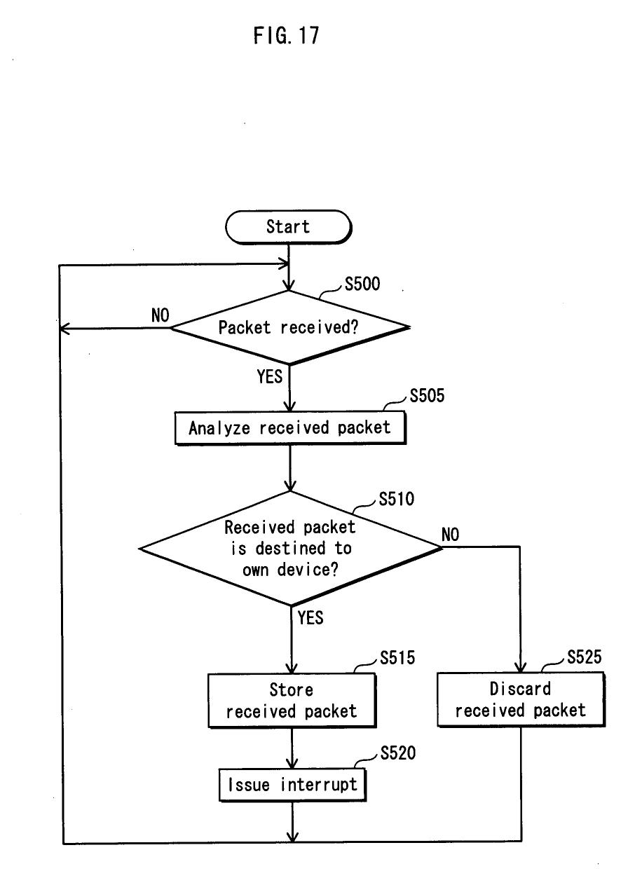

Here, the operation of the interrupt issuing unit 151e will be described with reference to the flowchart shown in FIG. 17.

It is presumed here that the interrupt issuing unit 151e preliminarily stores, in the storage area, the IP address notified from the CPU 104e.

The interrupt issuing unit 151e judges whether a packet has been received from the base station 20e via the packet reception unit 150e (step S500).

When it judges that a packet has not been received (NO in step S500), the interrupt issuing unit 151e returns to-step S500.

When it judges that a packet has been received (YES in step S500), the interrupt issuing unit 151e analyzes the received packet (step S505), and determines whether the received packet is a packet destined for the own device (step S510), in accordance with the analysis result.

When it judges that the received packet is a packet destined for the own device (YES in step S510), the interrupt issuing unit 151e stores the received packet into the reception packet buffer 120e (step S515). The interrupt issuing unit 151e then issues an interrupt by transmitting an interrupt signal to the CPU 104e (step S520). After issuing the interrupt, the interrupt issuing unit 151e returns to step S500.

When it judges that the received packet is not a packet destined for the own device (NO in step S510), the interrupt issuing unit 151e discards the received packet (step S525), and returns to step S500.

5.3 Modifications

Up to now, the present invention has been described through Embodiment 5. However, the present invention is not limited to the embodiment, but includes, for example, the following modifications.

(1) In Embodiment 5 described above, a radio transmission path is used to transmit/receive a packet. However, a wired transmission path may be used instead.

(2) In Embodiment 5 described above, an IP address, which corresponds to the network layer, is specified as a destination address of a packet, and the received packet is checked for the IP address. However, the present invention is not limited to this. An address of the own terminal in any protocol layer of the OSI reference model may be specified, the received packet may be checked for the specified address, and an interrupt may be issued when it is confirmed by the check that the received packet is destined for the own device.

(3) The present invention may be any combination of the above-described embodiment and modifications.

5.4 Summary

With the above-described structure of Embodiment 5 in which the network chip of the network transmission/reception device issues an interrupt to the CPU only when the address of the own terminal matches the destination address, it is possible to reduce the number of interrupts and thereby save the power.

### 6. Embodiment 6

A transmission/reception system 1f as another preferred embodiment of the present invention will be described in the following, with reference to the attached drawings.

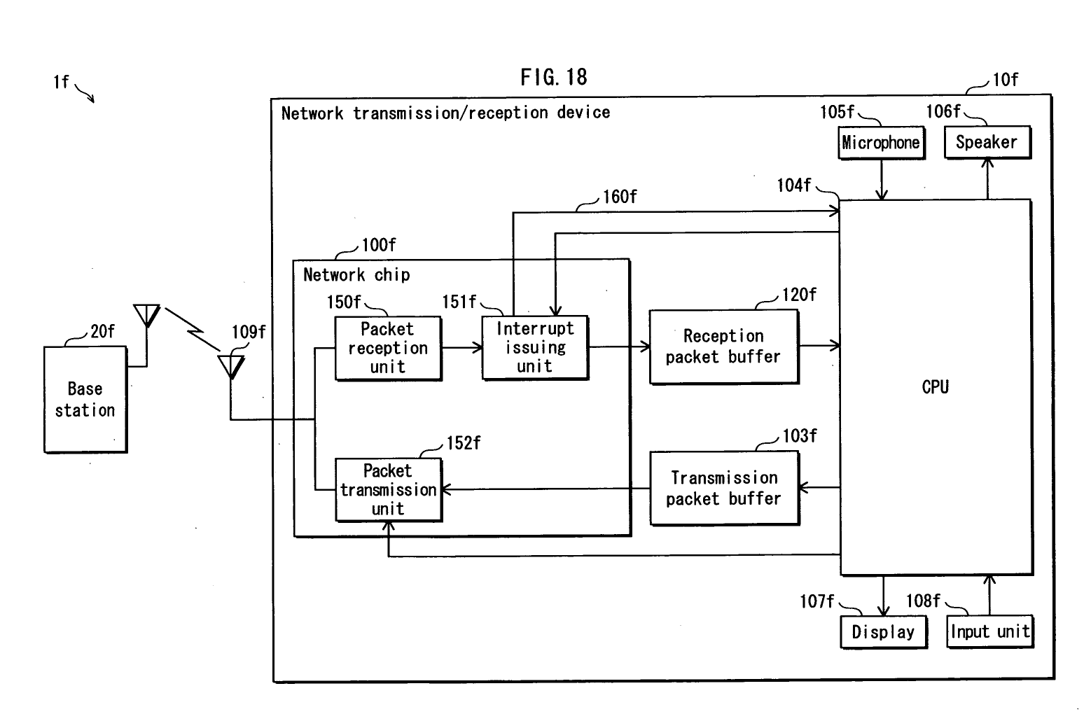

The transmission/reception system 1f, as shown in FIG. 18, includes a network transmission/reception device 10f and a base station 20f.

The network transmission/reception device 10f and the base station 20f perform a network communication therebetween by transmitting/receiving packets using a radio transmission path.

The packets that the network transmission/reception device 10f receives from the base station 20f are realtime packets and not-realtime packets. However, as is different from Embodiments 1 and 2, in the present embodiment, the network transmission/reception device 10f does not distinguish between the realtime packets and the not-realtime packets.

In the present embodiment, it is presumed that the burst transfer by the TXOP limit (Transmission Opportunity Limit) that is defined in “IEEE 802.11e” is supported.

Here, the burst transfer by the TXOP limit will be described. In the burst transfer by the TXOP limit defined in “IEEE 802.11e”, a continuous transmission/reception of packets can be performed during a burst transfer period that is given from the base station (AP) to the network transmission/reception device (STA).

The burst transfer period is determined for each TID indicated in the packet format 200 shown in FIG. 2, and is indicated by a beacon packet.

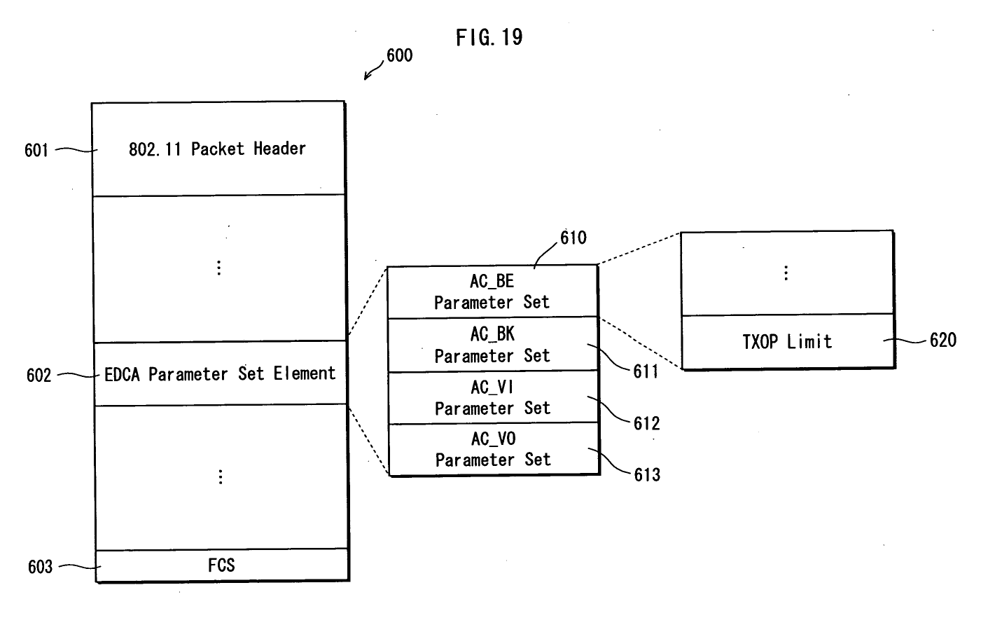

FIG. 19 shows a beacon packet format 600 indicating the data structure of the beacon packet that includes data indicating the burst transfer period by the TXOP limit.

The beacon packet format 600 includes an 802.11 packet header 601, an EDCA parameter set element 602, and an FCS 603.

It should be noted here that although not illustrated FIG. 19, the beacon packet format 600 also includes an SSID as is the case with the beacon packet format 300 shown in FIG. 10. The definition of data for use in the 802.11 packet header 601, EDCA parameter set element 602, and FCS 603 is known, and description thereof is omitted here. The following describes the EDCA parameter set element 602 briefly.

The EDCA parameter set element 602, as shown in FIG. 19, includes an AC_BE parameter set 610, an AC_BK parameter set 611, an AC_VI parameter set 612, and an AC_VO parameter set 613. In these parameter sets, parameters of AC (Access Category) indicated by each TID are stored.

The AC_BE parameter set 610 stores parameters corresponding to a best effort packet, namely a packet with TID=0, 3, and includes a TXOP limit 620 that indicates a burst transfer period for the best effort packet.

The AC_BK parameter set 611 stores parameters corresponding to a background packet, namely a packet with TID=1, 2, and includes a TXOP limit (not illustrated) that indicates a burst transfer period for the background.

The AC_VI parameter set 612 stores parameters corresponding to a video packet, namely a packet with TID=4, 5, and includes a TXOP limit (not illustrated) that indicates a burst transfer period for the video packet.

The AC_VO parameter set 613 stores parameters corresponding to a voice packet, namely a packet with TID=6, 7, and includes a TXOP limit (not illustrated) that indicates a burst transfer period for the voice packet.

The following will describe a burst transfer of a packet using the TXOP limit (burst transfer period).

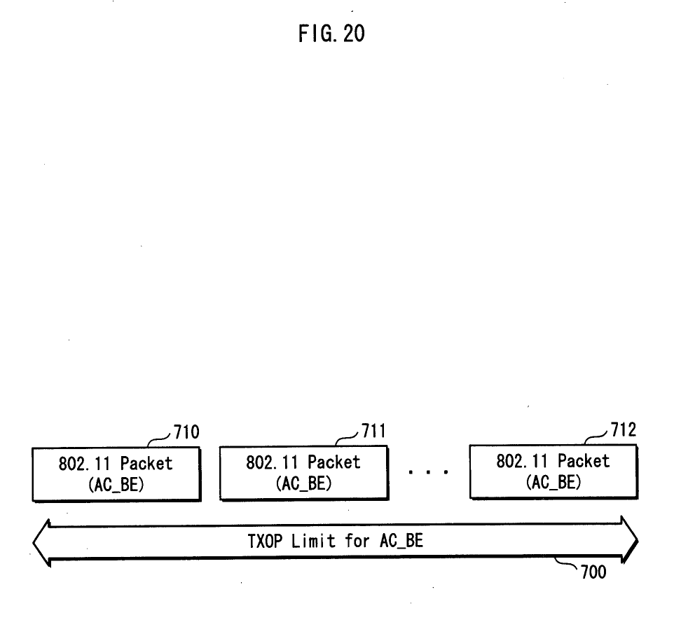

FIG. 20 shows a burst transfer for a best effort packet.

In a burst transfer period (TXOP Limit for AC_BE) 700 for a best effort packet, as shown in FIG. 20, packets 710, 711, . . . 712 with TID=0, 3 belonging to AC_BE are transmitted from a base station (AP) to a network transmission/reception device (STA) In this way, it is possible to transmit/receive packets continuously during a burst transfer period indicated by the TXOP Limit for AC_BE of beacon. In the conventional 802.11 network, it is necessary to acquire a transmission chance for each packet, using a mechanism called “back off”. However, as described above, in the burst transfer by the TXOP Limit conforming to the 802.11e, it is possible to transmit/receive packets continuously between a base station (AP) and a network transmission/reception device (STA).

It is presumed here that the length of the burst transfer period in the present embodiment is shorter than a delay time allowed for to the realtime packets.

The following will describe the structure and operation of the network transmission/reception device 10f.

6.1 Structure of Network Transmission/Reception Device 10f

The network transmission/reception device 10f, as shown in FIG. 18, includes a network chip 100f, a reception packet buffer 120f, a transmission packet buffer 103f, a CPU 104f, a microphone 105f, a speaker 106f, a display 107f, an input unit 108f, and an antenna 109f.

It is presumed here that the data input/output between the CPU 104f and each of the microphone 105f, the speaker 106f, the display 107f, and the input unit 108f is performed via a bus (not illustrated).

(1) Reception Packet Buffer 120f

The reception packet buffer 120f has an area for storing one or more received packets.

It is presumed here that the size of the area of the reception packet buffer 120f is large enough to store one or more received packets.

(2) Transmission Packet Buffer 103f

The transmission packet buffer 103f is the same as the transmission packet buffer 103 shown in Embodiment 1, and description thereof is omitted here.

(3) Network Chip 100f

The network chip 100f, as shown in FIG. 18, includes a packet reception unit 150f, an interrupt issuing unit 151f, and a packet transmission unit 152f.

The network chip 100f receives a packet from the base station 20f via the antenna 109f, and analyzes the received packet. The network chip 100f determines whether or not to issue an interrupt to the CPU 104f in accordance with the analysis result of the received packet, and performs a control according to the determination.

Further, the network chip 100f transmits packets to the base station 20f via the antenna 109f.

(3-1) Packet Reception Unit 150f

The packet reception unit 150f, upon receiving a packet from the base station 20f via the antenna 109f, outputs the received packet to the interrupt issuing unit 151f.

(3-2) Interrupt Issuing Unit 151f

The interrupt issuing unit 151f preliminarily stores information indicating a predetermined time period (for example, 50 ms) and a predetermined number (for example, 10).

The interrupt issuing unit 151f has a storage area for storing TXOP limits in correspondence with each AC (Access Category).

The interrupt issuing unit 151f receives TXOP limits corresponding to each AC from the CPU 104f and stores the received TXOP limits in the storage area.

### <When Beacon Packet is Received>

The operation performed after the interrupt issuing unit 151f receives a beacon packet is the same as the operation shown in Embodiment 4, and description thereof is omitted here.

It should be noted her that the operation performed after the interrupt issuing unit 151f receives a beacon packet may be the same as a conventional operation.

### <When Realtime or Not-Realtime Packet is Received>

In the following description, it is presumed that the interrupt issuing unit 151f stores, in the storage area, TXOP limits in correspondence with each AC.

Upon newly receiving a packet (realtime packet or not-realtime packet) from the packet reception unit 150f, the interrupt issuing unit 151f analyzes the newly received packet. In the present example, the interrupt issuing unit 151f obtains a TID from the newly received packet.

The interrupt issuing unit 151f obtains, from the storage area, a TXOP limit (burst transfer period) that corresponds to the received packet, in accordance with the analysis result. In the present example, the interrupt issuing unit 151f obtains a burst transfer period that corresponds to the TID contained in the newly received packet. The interrupt issuing unit 151f stores the newly received packet into the reception packet buffer 120f.

The interrupt issuing unit 151f receives packets of the same type as the newly received packet during the obtained burst transfer period, and stores the received packets into the reception packet buffer 120f.

The interrupt issuing unit 151f issues an interrupt by transmitting an interrupt signal to the CPU 104f via the signal line 160f after the predetermined time period, the value of which is preliminarily stored, passes since the start packet in the reception packet buffer 120f was received, or after the number of packets stored in the reception packet buffer 120f reaches the predetermined number that is preliminarily stored.

Here, the operation of the interrupt issuing unit 151f when it receives a realtime packet or a not-realtime packet will be described more specifically.

The interrupt issuing unit 151f includes an interrupt control unit for controlling the issuance of interrupts and a timer unit for measuring a time.

When the received packet is a realtime packet or a not-realtime packet, the interrupt control unit stores the received packet into the reception packet buffer 120f, and activates the timer unit. The timer unit measures a time period until the predetermined time period passes. Here, the interrupt control unit does not activate the timer unit when the timer unit has already been activated, and only stores the received packet into the reception packet buffer 120f.

When the measured time period reaches the predetermined time period, the timer unit outputs an interrupt issuance notification, which indicates that an interrupt should be issued, to the interrupt control unit, and stops measuring the time period. Upon receiving the interrupt issuance notification, the interrupt control unit issues an interrupt by transmitting an interrupt signal to the CPU 104f via the signal line 160f.

(3-3) Packet Transmission Unit 152f

The packet transmission unit 152f is the same as the packet transmission unit 152 shown in Embodiment 1, and description thereof is omitted here.

(4) CPU 104f

The CPU 104f controls, the entire network transmission/reception device 10f.

The CPU 104f outputs the IP address of the own device to the interrupt issuing unit 151f.

Upon receiving an interrupt signal from the interrupt issuing unit 151f, the CPU 104f obtains a packet stored in the reception packet buffer 120f.

When the obtained packet is a beacon packet, the CPU 104f obtains TXOP limits corresponding to each AC, from the obtained beacon packet, and transmits the obtained TXOP limits corresponding to each AC, to the interrupt issuing unit 151f.

When the obtained packet is a realtime packet or a not-realtime packet, the CPU 104f performs a process onto the obtained packet.

The CPU 104f deletes the packets after it performs the processes thereonto. Namely, a buffer stores no packet after the CPU 104f performs processes onto all packets stored in the buffer.

The processes performed onto the received packets are the same as conventional ones, and detailed description thereof is omitted here.

Upon receiving audio data from the microphone 105f, the CPU 104f generates one or more transmission packets by converting the received audio data into packets, and stores the generated one or more transmission packets into the transmission packet buffer 103f.

Also, upon receiving transmission data (for example, character data) to be transmitted to the base station 20f, from the input unit 108f, the CPU 104f generates one or more transmission packets by converting the received transmission data into packets, and stores the generated one or more transmission packets into the transmission packet buffer 103f.

When it starts to transmit a transmission packet, the CPU 104f transmits a transmission request signal to the packet transmission unit 152f.

The technology for converting data into packets is known, and description thereof is omitted here.

Further, upon receiving an instruction regarding the operation of the network transmission/reception device 10f from the input unit 108f, the CPU 104f controls the operation of the network transmission/reception device 10f in accordance with the received instruction.

(5) Microphone 105f

The microphone 105f is the same as the microphone 105 shown in Embodiment 1, and description thereof is omitted here.

(6) Speaker 106f

The speaker 106f is the same as the speaker 106 shown in Embodiment 1, and description thereof is omitted here.

(7) Display 107f

The display 107f is the same as the display 107 shown in Embodiment 1, and description thereof is omitted here.

(8) Input Unit 108f

The input unit 108f is the same as the input unit 108 shown in Embodiment 1, and description thereof is omitted here.

6.2 Operation of Network Transmission/Reception Device

(1) Operation of Interrupt Issuing Unit 151f

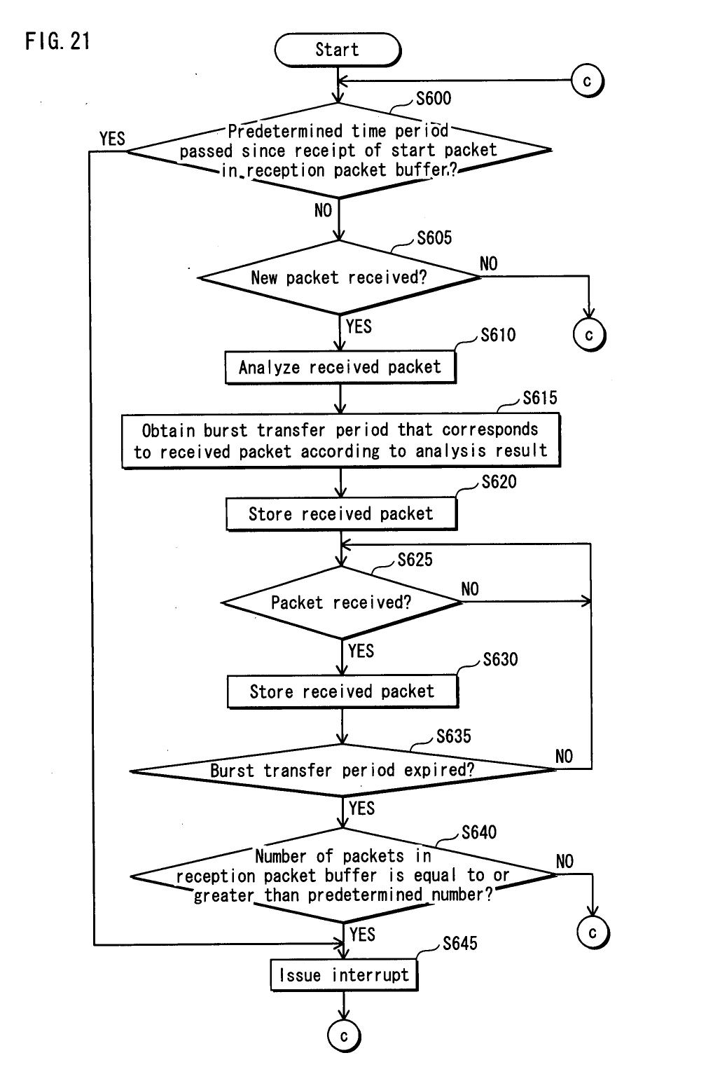

Here, the operation of the interrupt issuing unit 151f will be described with reference to the flowchart shown in FIG. 21.

It is presumed here that the interrupt issuing unit 151f preliminarily stores, in the storage area, TXOP limits which correspond to each TID.

The interrupt issuing unit 151f judges whether or not a predetermined time period has passed since receipt of the start packet in the reception packet buffer 120f (step S600).

When it judges that the predetermined time period has not yet passed (NO in step S600), the interrupt issuing unit 151f judges whether or not a new packet has been received from the base station 20f via the packet reception unit 150f (step S605).

When it judges that a packet has not been received (NO in step S605), the interrupt issuing unit 151f returns to step S600.

When it judges that a packet has been received (YES in step S605), the interrupt issuing unit 151f analyzes the received new packet (step S610), and according to the analysis result, obtains a TXOP limit (burst transfer period) that corresponds to received packet, from the storage area (step S615). The interrupt issuing unit 151f stores the received new packet into the reception packet buffer 120f (step S620).

The interrupt issuing unit 151f judges whether or not a packet has been received from the base station 20f via the packet reception unit 150f (step S625).

When it judges that a packet has not been received (NO in step S625), the interrupt issuing unit 151f returns to step S625.

When it judges that a packet has been received (YES in step S625), the interrupt issuing unit 151f stores the received packet into the reception packet buffer 120f (step S630).

The interrupt issuing unit 151f then judges whether or not the obtained burst transfer period has expired (step S635) When it judges that the burst transfer period has not expired (NO instep S635), the interrupt issuing unit 15f returns to step S625.

When it judges that the burst transfer period has expired (YES in step S635), the interrupt issuing unit 151f judges whether or not the number of packets in the reception packet buffer 120f is equal to or greater than a predetermined number (step S640). When it judges that the number of packets is smaller than the predetermined number (NO in step S640), the interrupt issuing unit 151f returns to step S600. When it judges that the number of packets is equal to or greater than the predetermined number (YES in step S640), the interrupt issuing unit 151f issues an interrupt by transmitting an interrupt signal to the CPU 104f (step S645). After issuing the interrupt, the interrupt issuing unit 151f returns to step S600.

When it judges that the predetermined time period has passed since the receipt of the start packet in the reception packet buffer 120f (YES in step S600), the interrupt issuing unit 151f performs step S645 and onwards.

6.3 Modifications

Up to now, the present invention has been described through Embodiment 6. However, the present invention, is not limited to the embodiment, but includes, for example, the following modifications.

(1) In Embodiment 6 described above a radio transmission path is used to transmit/receive a packet. However, a wired transmission path may be used instead.

(2) In Embodiment 6 described above as the burst transfer, the burst transfer by the TXOP Limit conforming to the 802.11e is performed. However, not limited to this, the present invention is applicable to network transmission/reception devices that perform any other burst transfers.

Further, when the burst period has a fixed length, there is no need for the CPU to send information of the burst period to the network chip, regardless of the type of packet.

(3) In Embodiment 6 described above, an interrupt is issued at a timing when the predetermined time period passes since the receipt of the start packet in the reception packet buffer 120f, or at a timing when the number of packets stored in the reception packet buffer 120f reaches the predetermined number. However, the present invention is not limited to this.

The interrupt issuing unit 151f may issue an interrupt immediately after the burst transfer period expires.

That is to say, during a period from the receipt of the first packet to the end of the burst transfer period, the interrupt issuing unit 151f only stores each received packet into the reception packet buffer 120f but does not issue, an interrupt to the CPU 104f, and the interrupt issuing unit 151f issues an interrupt to the CPU 104f after the burst transfer period expires.

The operation of the interrupt issuing unit 151f in this case corresponds to steps S605 through S635 and S645 shown in FIG. 21. Here, the process starts with step S605. When it judges that a packet has not been received (NO in step S605), the interrupt issuing unit 151f returns to step S605. When it judges that the burst transfer period has expired (YES in step S635), the interrupt issuing unit 151f performs step S645, and then returns to step S605.

(4) In Embodiment 6 described above, the CPU 104f obtains TXOP limits corresponding to each AC, from the beacon packet. However, the present invention is not limited to this.

The interrupt issuing unit 151f may obtain TXOP limits corresponding to each AC, from the beacon packet. In this case, the interrupt issuing unit 151f stores the obtained TXOP limits into the storage area.

(5) In Embodiment 6 described above, the length of the burst transfer period is shorter than a delay time allowed for to the realtime packets. However, the present invention is not limited to this.

In the case where the length of the burst transfer period is longer than a delay time allowed for to the realtime packets, the network transmission/reception device only needs to make a control such that the elapsed time since the receipt of the start packet (realtime packet) in the reception packet buffer does not exceed the delay time.

For example, during a burst transfer period for realtime packets, the network transmission/reception device issues an interrupt each time a realtime packet is received, as described in Embodiment 1, and during a burst transfer period for not-realtime packets, the network transmission/reception device operates in the same manner as in Embodiment 6.

(6) In Embodiment 6 described above, the operation during the burst transfer period is applied to both the realtime packets and the not-realtime packets. However, the present invention is not limited to this.

The operation during the burst transfer period may be applied only to the not-realtime packets.

Alternatively, the operation during the burst transfer period may be applied only to the realtime packets.

(7) The present invention may be any combination of the above-described embodiment and modifications.

6.4 Summary

According to Embodiment 6, in the network transmission/reception device, which is included in a network system that supports the burst transfer, an interrupt is not issued from the network chip to the CPU until the burst transfer period expires, which reducing the number of interrupts.

### 7. Modifications

Up to now, the present invention has been described through the preferred embodiments thereof. However, the present invention is not limited to the embodiments, but includes, for example, the following modifications.

(1) The network transmission/reception device of the present invention may be any device insofar as the device performs transmission/reception of data by a packet communication with another device which is connected thereto by a network.

For example, the network transmission/reception device of the present invention may be a mobile phone.

(2) The concept of the CPU of the present invention includes the microprocessor (MPU: Micro Processing Unit).

(3) The above-described network chip is specifically a computer system that includes a microprocessor, ROM, RAM, and the like. A computer program is stored in the RAM. The microprocessor operates in accordance with the computer program and causes the network chip to achieve its functions. It should be noted here that the computer program is composed of a plurality of instruction codes that issue instructions to the computer to achieve certain functions.

(4) The present invention may be methods shown by the above. The present invention may be a computer program that allows a computer to realize the methods, or may be digital signals representing the computer program.

Furthermore, the present invention may be a computer-readable recording medium such as a flexible disk, a hard disk, CD-ROM, MO, DVD, DVD-ROM, DVD RAM, BD (Blu-ray Disc), or a semiconductor memory, that stores the computer program or the digital signal. Furthermore, the present invention may be the computer program or the digital signal recorded on any of the aforementioned recording medium apparatuses.

Furthermore, the present invention may be the computer program or the digital signal transmitted via an electric communication line, a wireless or wired communication line, a network of which the Internet is representative, or a data broadcast.

Furthermore, the present invention may be a computer system that includes a microprocessor and a memory, the memory storing the computer program, and the microprocessor operating according to the computer program.

Furthermore, by transferring the program or the digital signal via the recording medium, or by transferring the program or the digital signal via the network or the like, the program or the digital signal may be executed by another independent computer system.

(5) The present invention may be any combination of the above-described embodiments and modifications.

### 8. INDUSTRIAL APPLICABILITY

The present invention can be manufactured and sold effectively, namely repetitively and continuously, in the industry for manufacturing and selling a device for transmitting/receiving data packets.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A network chip that is provided together with a central processing unit in a device and transmits and receives data packets to/from an external device that is connected thereto by a network, the network chip comprising:
an analyzing unit operable to analyze a data packet received from the external device;
a judging unit operable to judge, in accordance with a result of the analysis of the received data packet, whether or not an interrupt should be immediately issued to the central processing unit to request processing of the received data packet;
a timer unit operable to, when the judging unit judges that the interrupt should not be immediately issued, start measuring a time, and after a predetermined time period passes thereafter, make a notification that the interrupt should be issued; and
a control unit operable to issue the interrupt to the central processing unit, in accordance with either the analysis result or the notification made by the timer unit.

2. The network chip of claim 1, wherein
the data packet includes an attribute that indicates a level of importance of the data packet,
the analyzing unit analyzes the attribute of the data packet received from the external device,
the judging unit judges, in accordance with a result of the analysis of the attribute, whether or not the received data packet is important, and
the control unit issues the interrupt immediately to the central processing unit when the judging unit judges that the received data packet is important.

3. The network chip of claim 2, wherein
the attribute is type information that indicates a type of the data packet that is either a realtime packet or a not-realtime packet, where the realtime packet needs consideration of delay time, and the not-realtime packet does not need consideration of delay time,
the analyzing unit obtains a type from the received data packet by analyzing the received data packet, and
the judging unit judges that the received data packet is important when the type obtained by the analyzing unit indicates the realtime packet.

4. The network chip of claim 2, wherein
the attribute is application information that indicates an application by which the data packet should be processed,
the network chip is, connected to the network but is not connected in an application level, and preliminarily stores specification information that indicates an application specified by the central processing unit,
the analyzing unit analyzes whether or not the received data packet is a data packet of an application, and
when the analyzing unit analyzes that the received data packet is a data packet of an application, the judging unit judges, in accordance with the application information included in the received data packet, whether or not the received data packet is a data packet of the application indicated by the specification information, and judges that the received data packet is important when the judging unit judges that the received data packet is a data packet of the application indicated by the specification information.

5. The network chip of claim 4, wherein
the application information is a first port number for identifying an application by which the data packet should be processed,
the specification information is a second port number for identifying the application specified by the central processing unit, and
the judging unit judges that the received data packet is a data packet of the application indicated by the specification information when the first port number matches the second port number.

6. The network chip of claim 2, wherein
the attribute is a network identifier for identifying the network,
the network chip is not connected to the network and preliminarily stores a specification identifier for identifying a network specified by the central processing unit,
the analyzing unit obtains the network identifier from the received data packet by analyzing the received data packet, and
the judging unit judges whether or not the network identifier obtained from the received data packet matches the preliminarily stored specification identifier, and judges that the received data packet is important when the judging unit judges that the network identifier matches the specification identifier.

7. The network chip of claim 6, wherein
the data packet including the network identifier is a beacon packet,
the analyzing unit obtains the network identifier from the received beacon packet by analyzing the received beacon packet, and
the judging unit judges whether or not the network identifier obtained from the received beacon packet matches the specification identifier.

8. The network chip of claim 2, wherein
the attribute is destination information that indicates a transmission destination of the data packet,
the analyzing unit obtains the destination information by analyzing the received data packet, and
the judging unit judges whether or not the transmission destination indicated by the destination information is the device that includes the network chip, and judges that the received data packet is important when the judging unit judges that the transmission destination indicated by the destination information is the device that includes the network chip.

9. The network chip of claim 8, wherein
the destination information is a destination IP address for identifying a transmission destination device,
the network chip preliminarily stores a device IP address that is assigned to the device that includes the network chip, and
the judging unit judges that the data packet is destined for the device that includes the network chip when the device IP address matches the destination IP address.

10. The network chip of claim 1, wherein
the received data packet includes type information that indicates a type of the data packet that is either a realtime packet or a not-realtime packet, where the realtime packet needs consideration of delay time, and the not-realtime packet does not need consideration of delay time,
the central processing unit processes one or more realtime packets stored in a predetermined storage area in a transmission process in which one or more data packets are transmitted to the external device,
the network chip manages times at which the one or more data packets are transmitted in the transmission process,
the analyzing unit obtains the type information from the received data packet, and stores the received data packet into the predetermined storage area when the type information indicates the realtime packet,
when the type information indicates the realtime packet, the judging unit judges whether or not a time period until a next data packet transmission is equal to or larger than a predetermined time period that is allowed for as a delay time, and
the control unit issues the interrupt immediately to the central processing unit when the judging unit judges that the time period until the next data packet transmission is equal to or larger than the predetermined time period.

11. The network chip of claim 10, wherein
the network chip includes a time storage are a preliminarily storing a transmission time interval at which data packets are transmitted, and manages the times at which the one or more data packets are transmitted, in accordance with the transmission time interval.

12. The network chip of claim 10, wherein
the network chip preliminarily stores history information that indicates transmission times at which a plurality of data packets were transmitted respectively in past, and
the judging unit detects a transmission time at which a next data packet is to be transmitted, in accordance with the history information, and judges whether the detected transmission time is within a predetermined time range.

13. The network chip of claim 1, wherein
data packets transmitted from the external device are classified into a plurality of types,
the external device transmits data packets of a same type to the network chip in one burst transfer period, where a plurality of burst transfer periods are provided respectively in correspondence with the plurality of types of data packets,
the network chip preliminarily stores time periods of the plurality of burst transfer periods that correspond to the plurality of types of data packets, and receives data packets of a same type in one burst transfer period,
the analyzing unit analyzes a data packet that is received first in a burst transfer period and obtains a time period of the burst transfer period corresponding to a type of the received data packet,
the judging unit judges whether or not a current time is within the burst transfer period based on the obtained time period of the burst transfer period, and
the control unit does not issue the interrupt immediately to the central processing unit when the judging unit judges that the current time is within the burst transfer period.

14. The network chip of claim 13, wherein
the network chip stores one or more data packets, which were received during an interrupt process, into a predetermined packet storage area,
after a burst transfer is completed, the judging unit judges whether a predetermined time period has passed since a receipt of a start data packet that is stored first in the predetermined packet storage area, and whether number of data packets stored in the predetermined packet storage area is equal to or larger than a predetermined number, and
the control unit issues the interrupt immediately to the central processing unit when the judging unit judges either that the predetermined time period has passed since the receipt of the start data packet or that the number of data packets stored in the predetermined packet storage area is equal to or larger than the predetermined number.

15. The network chip of claim 13, wherein
after a burst transfer is completed, the judging unit judges that the interrupt should be immediately issued, and the control unit issues the interrupt immediately to the central processing unit when the judging unit judges that the interrupt should be immediately issued.

16. A network transmission/reception device comprising a central processing unit and a network chip that transmits and receives data packets to/from an external device that is connected thereto by a network, wherein
the network chip includes:
an analyzing unit operable to analyze a data packet received from the external device;
a judging unit operable to judge, in accordance with a result of the analysis of the received data packet, whether or not an interrupt should be immediately issued to the central processing unit to request processing of the received data packet;
a timer unit operable to, when the judging unit judges that the interrupt should not be immediately issued, start measuring a time, and after a predetermined time period passes thereafter, make a notification that the interrupt should be issued; and
a control unit operable to issue the interrupt to the central processing unit, in accordance with either the analysis result or the notification made by the timer unit, wherein
the central processing unit processes the received data packet when the central processing unit receives the interrupt issued from the network chip.

17. The network transmission/reception device of claim 16, wherein
the data packet includes an attribute that indicates a level of importance of the data packet,
the analyzing unit analyzes the attribute of the data packet received from the external device,
the judging unit judges, in accordance with a result of the analysis of the attribute, whether or not the received data packet is important, and
the control unit issues the interrupt immediately to the central processing unit when the judging unit judges that the received data packet is important.

18. The network transmission/reception device of claim 17, wherein
the attribute is type information that indicates a type of the data packet that is either a realtime packet or a not-realtime packet, where the realtime packet needs consideration of delay time, and the not-realtime packet does not need consideration of delay time,
the analyzing unit obtains a type from the received data packet by analyzing the received data packet, and
the judging unit judges that the received data packet is important when the type obtained by the analyzing unit indicates the realtime packet.

19. The network transmission/reception device of claim 17, wherein
the attribute is application information that indicates an application by which the data packet should be processed,
the network chip is connected to the network but is not connected in an application level, and preliminarily stores specification information that indicates an application specified by the central processing unit,
the analyzing unit analyzes whether or not the received data packet is a data packet of an application, and
when the analyzing unit analyzes that the received data packet is a data packet of an application, the judging unit judges, in accordance with the application information included in the received data packet, whether or not the received data packet is a data packet of the application indicated by the specification information, and judges that the received data packet is important when the judging unit judges that the received data packet is a data packet of the application indicated by the specification information.

20. The network transmission/reception device of claim 19, wherein.
the application information is a first port number for identifying an application by which the data packet should be processed,
the specification information is a second port number for identifying the application specified by the central processing unit, and
the judging unit judges that the received data packet is a data packet of the application indicated by the specification information when the first port number matches the second port number.

21. The network transmission/reception device of claim 17, wherein
the attribute is a network identifier for identifying the network,
the network chip is not connected to the network and preliminarily stores a specification identifier for identifying a network specified by the central processing unit,
the analyzing unit obtains the network identifier from the received data packet by analyzing the received data packet, and
the judging unit judges whether or not the network identifier obtained from the received data packet matches the preliminarily stored specification identifier, and judges that the received data packet is important when the judging unit judges that the network identifier matches the specification identifier.

22. The network transmission/reception device of claim 21, wherein
the data packet including the network identifier is a beacon packet,
the analyzing unit obtains the network identifier from the received beacon packet by analyzing the received beacon packet, and
the judging unit judges whether or not the network identifier obtained from the received beacon packet matches the specification identifier.

23. The network transmission/reception device of claim 17, wherein
the attribute is destination information that indicates a transmission destination of the data packet,
the analyzing unit obtains the destination information by analyzing the received data packet, and
the judging unit judges whether or not the transmission destination indicated by the destination information is the device that includes the network chip, and judges that the received data packet is important when the judging unit judges that the transmission destination indicated by the destination information is the device that includes the network chip.

24. The network transmission/reception device of claim 23, wherein
the destination information is a destination IP address for identifying a transmission destination device,
the network chip preliminarily stores a device IP address that is assigned to the device that includes the network chip, and
the judging unit judges that the data packet is destined for the device that includes the network chip when the device IP address matches the destination IP address.

25. The network transmission/reception device of claim 16, wherein
the received data packet includes type information that indicates a type of the data packet that is either a realtime packet or a not-realtime packet, where the realtime packet needs consideration of delay time, and the not-realtime packet does not need consideration of delay time,
the central processing unit processes one or more realtime packets stored in a predetermined storage area in a transmission process in which one or more data packets are transmitted to the external device,
the network chip manages times at which the one or more data packets are transmitted in the transmission process,
the analyzing unit obtains the type information from the received data packet, and stores the received data packet into the predetermined storage area when the type information indicates the realtime packet,
when the type information indicates the realtime packet, the judging unit judges whether or not a time period until a next data packet transmission is equal to or larger than a predetermined time period that is allowed for as a delay time, and
the control unit issues the interrupt immediately to the central processing unit when the judging unit judges that the time period until the next data packet transmission is equal to or larger than the predetermined time period.

26. The network transmission/reception device of claim 25, wherein
the network chip includes a time storage area preliminarily storing a transmission time interval at which data packets are transmitted, and manages the times at which the one or more data packets are transmitted, in accordance with the transmission time interval.

27. The network transmission/reception device of claim 25, wherein
the network chip preliminarily stores history information that indicates transmission times at which a plurality of data packets were transmitted respectively in past, and
the judging unit detects a transmission time at which a next data packet is to be transmitted, in accordance with the history information, and judges whether the detected transmission time is within a predetermined time range.

28. The network transmission/reception device of claim 16, wherein
data packets transmitted from the external device are classified into a plurality of types,
the external device transmits data packets of a same type to the network chip in one burst transfer period, where a plurality of burst transfer periods are provided respectively in correspondence with the plurality of types of data packets,
the network chip preliminarily stores time periods of the plurality of burst transfer periods that correspond to the plurality of types of data packets, and receives data packets of a same type in one burst transfer period,
the analyzing unit analyzes a data packet that is received first in a burst transfer period and obtains a time period of the burst transfer period corresponding to a type of the received data packet,
the judging unit judges whether or not a current time is within the burst transfer period based on the obtained time period of the burst transfer period, and
the control unit does not issue the interrupt immediately to the central processing unit when the judging unit judges that the current time is within the burst transfer period.

29. The network transmission/reception device of claim 28, wherein
the network chip stores one or more data packets, which were received during an interrupt process, into a predetermined packet storage area,
after a burst transfer is completed, the judging unit judges whether a predetermined time period has passed since a receipt of a start data packet that is stored first in the predetermined packet storage area, and whether number of data packets stored in the predetermined packet storage area is equal to or larger than a predetermined number, and
the control unit issues the interrupt immediately to the central processing unit when the judging unit judges either that the predetermined time period has passed since the receipt of the start data packet or that the number of data packets stored in the predetermined packet storage area is equal to or larger than the predetermined number.

30. The network transmission/reception device of claim 28, wherein
after a burst transfer is completed, the judging unit judges that the interrupt should be immediately issued, and
the control unit issues the interrupt immediately to the central processing unit when the judging unit judges that the interrupt should be immediately issued.
